(19) United States
(12) Patent Application Publication
(10) Pub. No.: US 2012/0254056 A1
(43) Pub. Date: Oct. 4, 2012

(54) INSTITUTIONAL FINANCIAL AID ANALYSIS

(75) Inventors: Mark Jeffrey MAX, Reisterstown, MD (US); Jason Gregory White, Towson, MD (US); Matthew Charles Kelly, Baltimore, MD (US)

(73) Assignee: BLACKBOARD INC., Washington, DC (US)

(21) Appl. No.: 13/077,672

(22) Filed: Mar. 31, 2011

(51) Int. Cl. G06Q 50/00

(52) U.S. Cl. 705/327

(57) ABSTRACT

Systems for analytically combining student admissions data, enrollment data, and financial aid data to present relationships therein, are described. One exemplary system includes a processor configured to obtain admissions data, enrollment data, and financial aid data from respective databases in memory, and identify student data shared among any of at least two of them. The processor is further configured to associate each of the identified student data with a unique identifier, receive a first query for a report for a subset of the identified student data, and provide the report. The report is generated by detecting at least two of admissions data, enrollment data, and financial aid data for the subset using the unique identifiers associated with the subset. The report includes a relationship between any of at least two of admissions data, enrollment data, and financial aid data for the subset. Methods and machine-readable media are also described.

### BACKGROUND

1. Field

The present disclosure generally relates to data analysis systems, and particularly to the analysis of institutional data.

2. Description of the Related Art

Institutions such as colleges and universities offer various forms of financial aid to financially assist students considering enrolling at the institution. The financial aid offers can come in many forms, including grants, loans, work-study, and reductions in cost of attendance. Each student is typically considered individually to determine how much financial aid that student should be offered. The student then decides, based on the financial aid offer, among other factors, whether or not to attend the institution. Every student offered admission to a university, however, does not necessarily receive an offer of financial aid, and furthermore every student who is either offered admission and/or financial aid does not necessarily attend and/or eventually graduate from the institution.

Institutions often separately store data for students for each of these different processes. Namely, an institution often maintains separate databases or modules within a larger database to store data for (1) offers of admission for students to attend the institution, (2) financial aid applications and offers to a subset of those students offered admission or currently enrolled, and (3) the academic record of students who eventually decided to enroll at the institution. The data relating to these three different groups usually remains unusable for cross-data analysis between the datasets. For example, an institution is unable to use the data to make informed financial aid decisions that affect admissions and/or enrollment and retention.

### SUMMARY

The present disclosure provides embodiments of analytics systems for identifying admissions, financial aid, and enrollment information for a common group, such as students and applicants, and combining the information into a shared database that provides reports identifying one or more relationships between the admissions, financial aid, and enrollment information. As one example, the reports can identify the affect of financial aid offers made by an institution to new applicants on enrollment at the institution. Custom reports can also be provided by a user interface in response to queries received by a user.

In certain embodiments of the present disclosure, a system for analytically combining student admissions data, enrollment data, and financial aid data to present relationships therein, is disclosed. The system includes a memory and a processor. The memory includes a first database storing admissions data for a plurality of students, a second database storing enrollment data for a plurality of students, and a third database storing financial aid data for a plurality of students. The processor is configured to obtain the admissions data, the enrollment data, and the financial aid data, and identify, from the admissions data, the enrollment data, and the financial aid data, student data shared among any of at least two of the admissions data, the enrollment data, and the financial aid data. The processor is further configured to associate each of the identified student data with a unique identifier, receive, from a user, a first query for a report for a subset of the identified student data, and provide, to the user, the report for the subset of the identified student data. The report is generated by detecting at least two of admissions data, enrollment data, and financial aid data for the subset of the identified student data using the unique identifiers associated with the subset of the identified student data. The report includes a relationship between any of at least two of admissions data for the subset of the identified student data, enrollment data for the subset of the identified student data, and financial aid data for the subset of the identified student data.

In certain embodiments of the present disclosure, a method for analytically combining student admissions data, enrollment data, and financial aid data to present relationships therein, is disclosed. The method includes obtaining admissions data from an admissions database for a plurality of students, enrollment data from an enrollment database for a plurality of students, and financial aid data from a financial aid database for a plurality of students. The method also includes identifying, from the admissions data, the enrollment data, and the financial aid data, students shared among any of at least two of the admissions data, the enrollment data, and the financial aid data. The method further includes associating each of the identified student data with a unique identifier, and receiving, from a user, a first query for a report for a subset of the identified student data. The method yet further includes providing, to the user, the report for the subset of the identified student data. The report is generated by detecting at least two of admissions data, enrollment data, and financial aid data for the subset of the identified student data using the unique identifiers associated with the subset of the identified student data. The report includes a relationship between any of at least two of admissions data for the subset of the identified student data, enrollment data for the subset of the identified student data, and financial aid data for the subset of the identified student data.

In certain embodiments of the present disclosure, a machine-readable storage medium comprising machine-readable instructions for causing a processor to execute a method for analytically combining student admissions data, enrollment data, and financial aid data to present relationships therein, is disclosed. The method includes obtaining admissions data from an admissions database for a plurality of students, enrollment data from an enrollment database for a plurality of students, and financial aid data from a financial aid database for a plurality of students. The method also includes identifying, from the admissions data, the enrollment data, and the financial aid data, students shared among any of at least two of the admissions data, the enrollment data, and the financial aid data. The method further includes associating each of the identified student data with a unique identifier, and receiving, from a user, a first query for a report for a subset of the identified student data. The method yet further includes providing, to the user, the report for the subset of the identified student data. The report is generated by detecting at least two of admissions data, enrollment data, and financial aid data for the subset of the identified student data using the unique identifiers associated with the subset of the identified student data. The report includes a relationship between any of at least two of admissions data for the subset of the identified student data, enrollment data for the subset of the identified student data, and financial aid data for the subset of the identified student data.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an exemplary architecture for analytically combining student admissions data, enrollment data, and financial aid data to present relationships therein in accordance with certain embodiments.

FIG. 2 is an exemplary process for analytically combining student admissions data, enrollment data, and financial aid data to present relationships therein in accordance with the architecture of FIG. 1.

FIGS. 3A-3FF are exemplary screenshots of reports generated from analytically combining student admissions data, enrollment data, and financial aid data to present relationships therein.

FIG. 4 is a block diagram illustrating an example of a computer system with which the client and servers of FIG. 1 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The present disclosure is directed to an analytics system, such as an analytics server, that is in certain aspects configured to obtain admissions data for students from an admissions database, enrollment data for students from an enrollment database, and financial aid data for students from a financial aid database. The analytics system combines admissions data, enrollment data, and financial aid data into a single analytics database and allows a user to generate reports that present relationships between the admissions data, enrollment data, and financial aid data, such as to what extend the levels of financial aid offered to the students by an educational institution increased their likelihood of enrolling at the institution.

While many examples are provided herein in the context of an educational institution, the principles of the present disclosure contemplate other types of organizations as well. For example, corporations and governmental entities (e.g., administrative or military) offering salaries or bonuses as forms of financial aid are all considered within the scope of the present disclosure. An institution may also be a consortium of schools and/or campuses. In general terms, an institution is an operating unit and is, itself, made up of different operating units that may correspond to campuses, colleges, departments, sub-departments, etc. The systems and methods described herein do not require any particular arrangement of operating units but, instead, allow the institution to model its organization into a hierarchy of operating units for purposes of management, planning, and reporting.

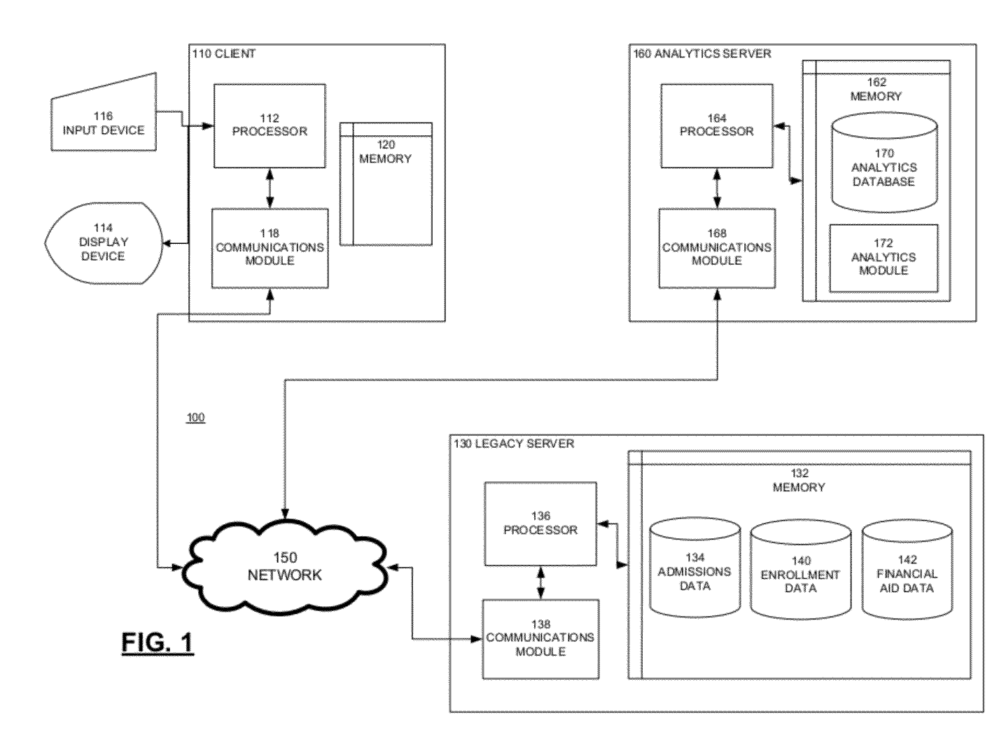

FIG. 1 illustrates an exemplary architecture 100 for analytically combining student admissions data, enrollment data, and financial aid data to present relationships therein in accordance with certain embodiments. The architecture 100 includes a client 110, a legacy server 130, and an analytics server 160 connected over a network 150 (e.g., the Internet) via respective communications modules 118, 138, and 168 (e.g., Ethernet cards).

The legacy server 130 of the architecture 100 is associated with one or many educational institutions. The legacy server 130 can be located at an institution remote to the analytics server 160, such as a university. In certain embodiments, the legacy server 130 is remote from the institution. In certain embodiments, the legacy server 130 is co-located with the analytics server 160. The legacy server 130 maintains an admissions data database 134, enrollment data database 140, and financial aid data database 142 (e.g., in enterprise resource planning (ERP) databases) for students associated with one or many institutions in separate databases in memory 132 due to the independent nature of the logging of such information. For example, the entity at an institution responsible for deciding on whether to offer admission to a student and tracking such offers and acceptances (e.g., admissions department) is often different than the entity that is responsible for deciding on financial aid offers and tracking such offers (e.g., financial aid department). Similarly, the entity that is responsible for tracking the enrollment and academic performance of students may be distinct from the previously mentioned entities responsible for admissions and financial aid.

Although the admissions data, enrollment data, and the financial aid data are illustrated as stored in separate databases 134, 140, and 142, the admissions data, enrollment data, and the financial aid data can be stored in a single database (e.g., in the memory 132 of the legacy server 130). Hence, the databases 134, 140, and 142 can be discernible portions (e.g., data sets) of a single database. Additionally, although the admissions data, enrollment data, and the financial aid data are illustrated as stored in the memory 132 of the legacy server, 130, the admissions data, enrollment data, and the financial aid data can be stored in the memory 162 of the analytics server 160 apart from the analytics database 160, or as a discernible portion of the analytics database 170.

The admissions data database 134 includes, for example, data on whether a student was offered admission to an institution (e.g., offered, accepted, provisional, conditional, withdrawn, deposited), the previous academic performance of the student (e.g., high school GPA, standardized examination score, such as on the Standardized Aptitude Test (SAT) or ACT), the student's intended major, and the student's intended status at the institution (e.g., freshman, transfer, graduate student). The enrollment data database 140 includes, for example, data on whether a student enrolled at an institution, in what courses the student enrolled, how the student performed in those courses, and whether the student graduated from the institution. The financial aid data database 142 includes, for example, data on whether a student received an offer of financial aid (e.g., loan, grant, work-study, or reduction in attendance cost), whether the student accepted the offer of financial aid, student demographic data (e.g., ethnicity, residency, and age), parental educational attainment, housing plans, Free Application for Federal Student Aid (FAFSA) data, what other forms of financial aid (e.g., family contribution) the student received, and cost data (e.g., estimated tuition and fees, housing rates). Although three databases 134, 140, and 142 are illustrated, other data is also compatible with the disclosed system, including alumni data and external data (e.g., clearinghouse data and other sources of student data). Such databases 134, 140, and 142 may be conventional databases

Certain embodiments of the analytics server 160 include a processor 164, the communications module 168, and a memory 162 that includes an analytics database 170 and an analytics module 172. The processor 164 of the analytics server 160 is configured to execute instructions, such as instructions physically coded into the processor 164, instructions received from software in memory 162, or a combination of both. For example, the processor 164 of the analytics server 160 is configured to execute instructions from the analytics module 172 causing the processor 164 to obtain admissions data from the admissions data database 134, enrollment data from the enrollment data database 140, and financial aid data from the financial aid data database 142 of the legacy server 130 over the network 150. The admissions data database 134, the enrollment data database 140, and the financial aid data database 142 can store data for different groups of students (e.g., not all students who are offered admission decide to enroll). Accordingly, the processor 164 is configured to identify, from the admissions data, the enrollment data, and the financial aid data, student data shared among any of at least two of the admissions data, the enrollment data, and the financial aid data (“identified student data”), and associate each of the identified student data with a unique identifier (e.g., a unique record identifier or a common identifier). For example, the processor 164 is configured to identify a student, an enrollment application (e.g., for the same or a different student, for the same or a different program), an academic course, a financial aid application, a semester or quarter at an institution that appears in at least two of the admissions data, the enrollment data, and the financial aid data, and then associate common data points together from the identification using a unique record identifier, The data, once associated using common data points, is then stored in the analytics database 170, as discussed in more detail below. As discussed herein, “students” can include both applicants to an institution who did not enroll at the institution, and students who previously enrolled at the institution but are not currently enrolled at the institution. The term “students,” therefore, is not limited to individuals currently enrolled at the institution.

This process of identification and association can be performed, for example, using a computer program for statistical analysis such as the Statistical Package for the Social Science and a common identifier such as a variation of a Social Security number, drivers license number, name, or other string. This process allows data from the admissions data database 134, the enrollment data database 140, and the financial aid data database 142 for each identified student data to be associated with a unique identifier and stored in the analytics database 170 in the memory 162 of the analytics server 160.

In certain aspects, the analytics database 170 comprises one or many fact tables (e.g., central tables of a data warehouse schema that contain measures and keys relating facts to dimension tables) stored in online analytical processing (OLAP) cubes (e.g., multidimensional data structures). Exemplary measures include admitted count, average GPA, retention rate, registration count, and course utilization, and facts measured within a subject area, such as admissions, student term, student plan, class schedule, class instruction, registration, degree awards, and student financials. Measures can be stored (e.g., based on stored data in relational fact tables) or calculated (e.g., calculated dynamically based on specified algorithms). Exemplary dimensions, which define how measures are segmented, include admissions dimensions (e.g., application method, applicant zip code, applicant financial aid interest, applicant housing interest, applicant high school, recruiting category, applicant status, admit category, applicant SAT band, applicant high school GPA band, applicant high school rank band, and applicant age band), faculty attributes dimensions (e.g., faculty, faculty rank, highest education level, and tenured status), graduates dimensions (e.g., graduate apply status, degree, and years to graduate band), institutional dimensions (e.g., term, career/plan, and academic organization), student term dimensions (e.g., academic level, academic standing, cohort/cohort, type, student term status, full time/part time, and credit hour band), class/grade dimensions (e.g., subject/class, course level, class type, grade, and GPA band), and student attributes dimensions (student, student citizenship, student ethnicity, student gender, student geography, and student age band). Dimension members include lists of values, and dimensions can be arranged in hierarchies to define how structures roll up (e.g., from day to month to quarter to year). In certain aspects, where there are gaps in the admissions data database 134, the enrollment data database 140, and the financial aid data database 142 that cannot be filled, a determination is made whether the missing data are relevant to storage in the analytics database 170, and the data is stored accordingly. In such circumstances, relevant data can be dynamically generated for storage in the analytics database 170 using other available data (e.g., determining a financial cost to a student by subtracting a financial aid offer from institution cost). For example, if financial aid data is not found for a student that has admissions data, then default financial aid values can be generated for the student that will not affect the reporting of financial aid data in the system for other students. The student's admissions data can still be reported using the system. Furthermore, access to the analytics database 170 can be restricted and otherwise secured as necessary.

In certain aspects, the financial aid data database 142 can include academic performance data for students having different academic backgrounds that have their academic performance ranked according to separate scales or standards. For example, one student can have an ACT score while another student can have an SAT score. The issue then arises of determining how to academically rank or otherwise categorize such students within the analytics database 170. Accordingly, the student academic performance data from the admissions data database 134 is standardized by the analytics module 172 for storage in the analytics database 170. For example, when the academic performance data for a first subset of the students identified in the identified student data (“identified students”) is associated with a first academic performance standard (e.g., the SAT exam) and the academic performance data for a second subset of the identified students is associated with a second academic performance standard (e.g., the ACT exam), the processor 164 is configured to generate, based on the number of the identified students, the academic performance data for the first subset, and the academic performance data for the second subset, a new academic performance standard (e.g., an academic ranking of students by groups).

Specifically, the first subset of the identified students (e.g., who have taken the SAT exam) is divided into a first set of a predetermined number of ordered groups (e.g., four groups) based on the performance of each of the identified students in the first subset according to the first academic performance standard (e.g., the first group, group 1, having the top 25% of SAT scores from the identified students, and on through the fourth group, group 4, having the bottom 25% of SAT scores). Similarly, the second subset of the identified students (e.g., who have taken the ACT exam) are divided into a second set of the predetermined number of ordered groups (e.g., four groups) based on the performance of each of the identified students in the second subset according to the second academic performance standard (e.g., the first group, group 1, having the top 25% of ACT scores from the identified students, and on through the fourth group, group 4, having the bottom 25% of ACT scores). The ranking of each of the respective ordered groups from the first set is associated with the corresponding group from the second set (e.g., group 1 of the SAT students is ranked as highly as group 1 of the ACT students).

Using the new academic performance standard, the academic performance data for each of the identified students is standardized into standardized academic performance data. Specifically, the processor 164 is configured to standardize the academic performance data for each of the identified students into standardized academic performance data by ranking each of the identified students according to their respective ordered group (e.g., group 1 of the SAT students and group 1 of the ACT students are included in the same group as the highest academic ranked students, and group 4 of the SAT students and group 4 of the ACT students are included in the same group and ranked as the lowest academic ranked students).

If the students that have different academic backgrounds (e.g., the first subset and the second subset of students) share an academic standard (e.g., each has a grade point average (GPA) on a 4.0 scale), then the processor 164 is configured to generate the new academic performance standard by dividing the students into a third set of the predetermined number of ordered groups (e.g., four groups) based on the performance of each of the identified students according to the shared academic standard (e.g., first group, group 1, having the top 25% of GPA scores from the identified students, and on through the fourth group, group 4, having the bottom 25% of GPA scores), and associate the ranking of each of the respective ordered groups from the third set with the corresponding groups from the first set and the second set (e.g., group 1 of the GPA student scores is ranked as highly as group 1 of the SAT students and group 1 of the ACT students). The processor 164 is further configured to standardize the academic performance data for each of the identified students into standardized academic performance data by assigning a first numeric value to each of the identified students from according to their respective ordered group (e.g., group 1 of the GPA student scores, group 1 of the SAT students, and group 1 of the ACT students each receive a value 1, and group 4 of the GPA student scores, group 4 of the SAT students, and group 4 of the ACT students each receive a value 4), and summing the numeric values associated with each of the identified students (e.g., a student in group 1 of the GPA student scores and group 2 of the ACT scores will have a summed value of 3, while another student in group 3 of the GPA student scores and group 4 of the SAT scores will have a summed value of 7). The identified students are then ranked (e.g., within the analytics database 170) according to their associated sum value (e.g., on a scale from 2-8, with 2 being the highest performing academic students).

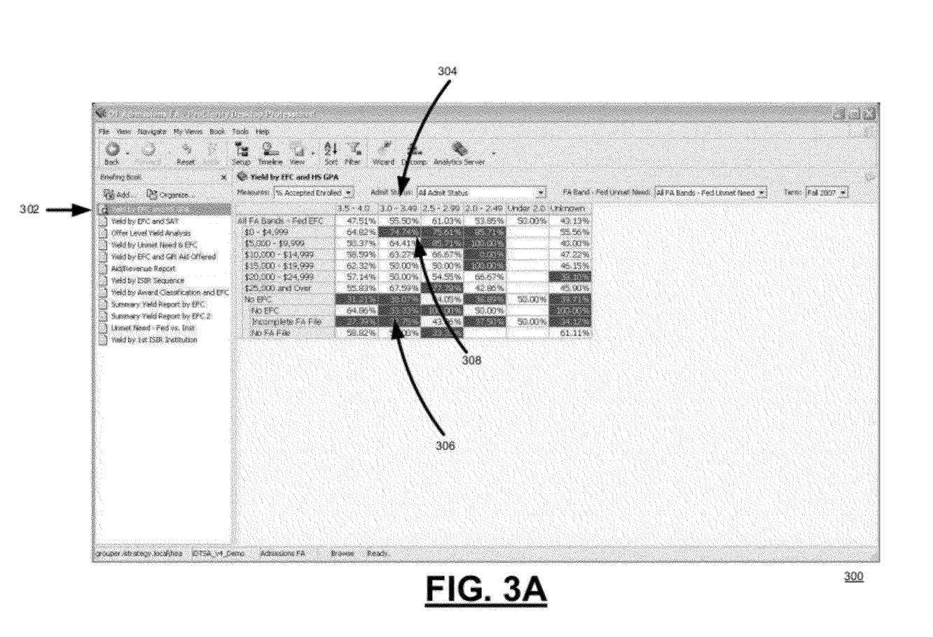

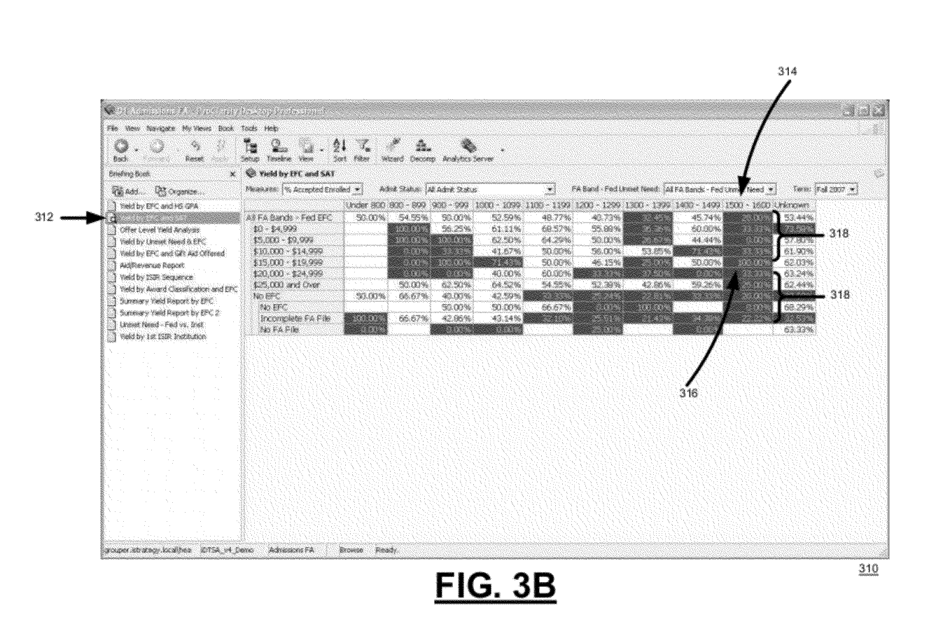

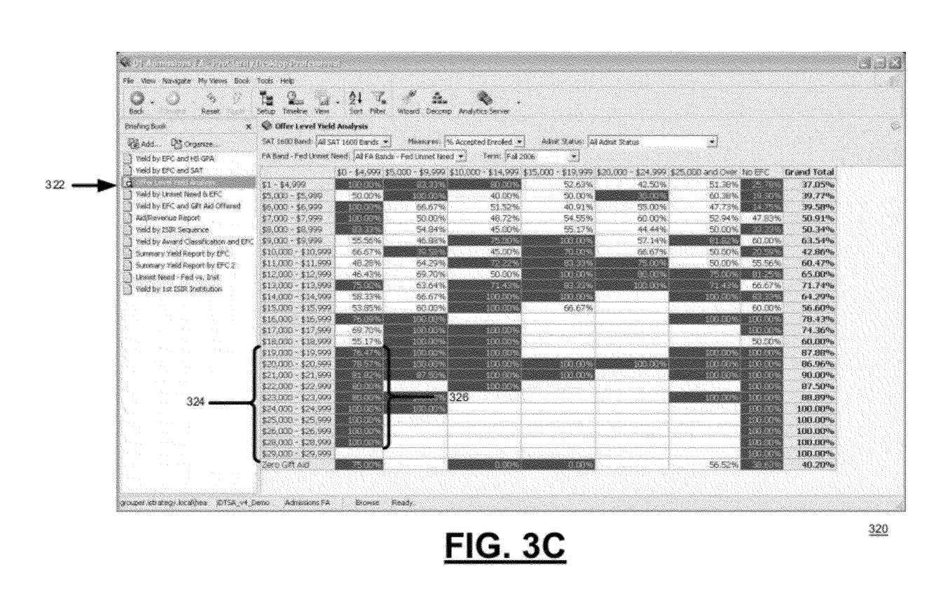

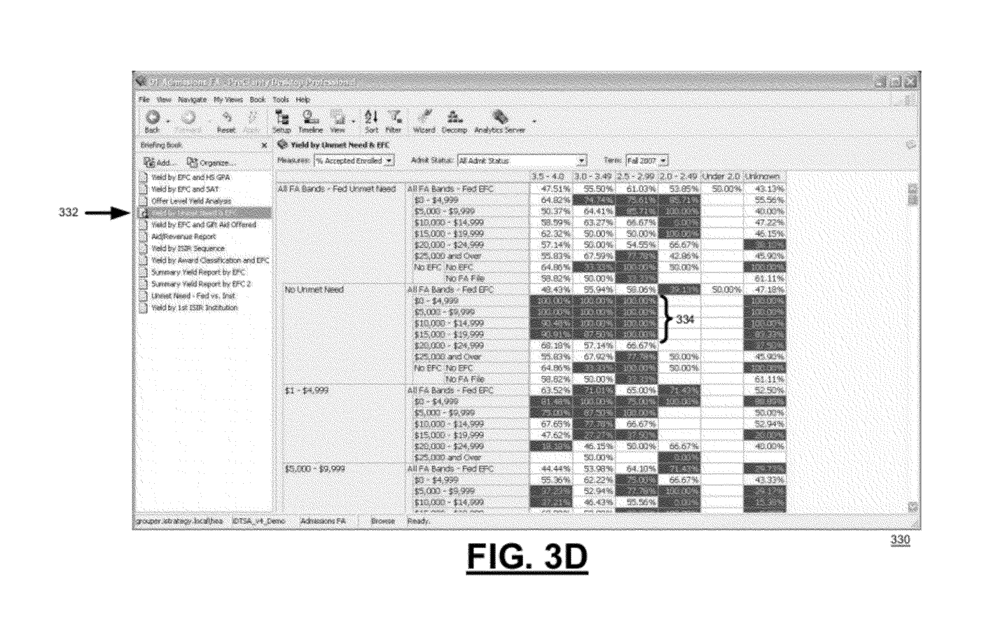

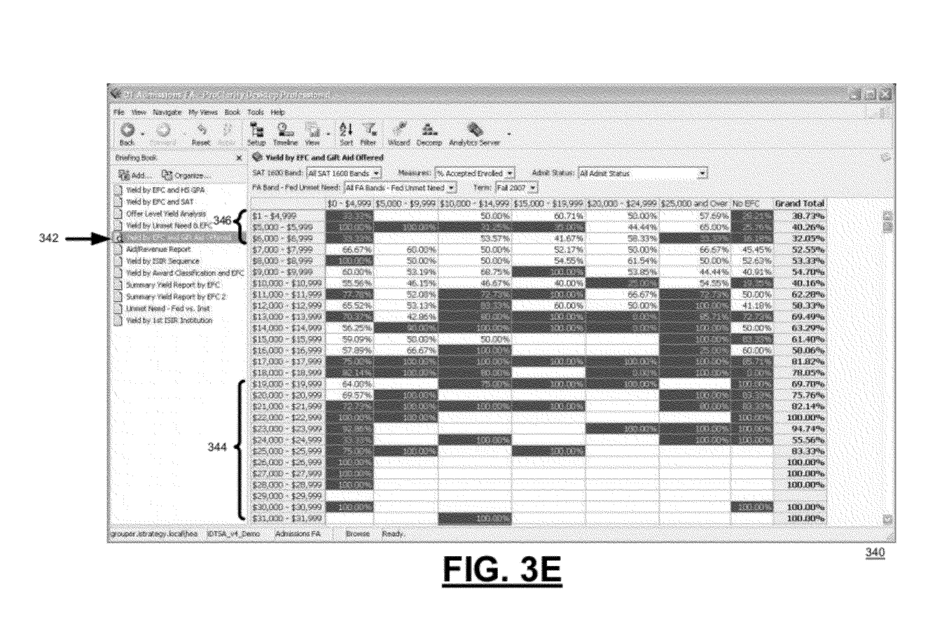

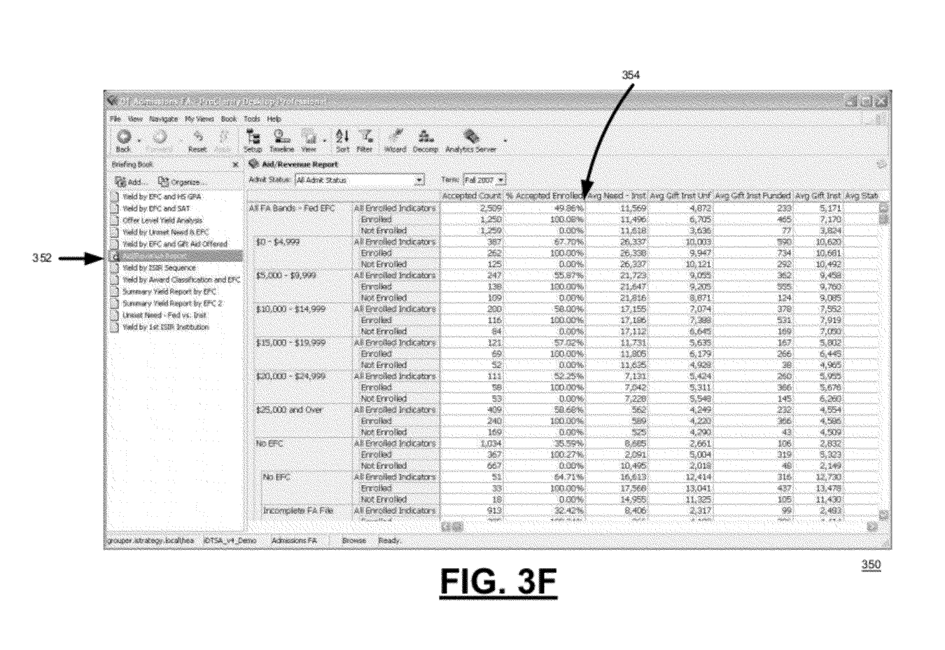

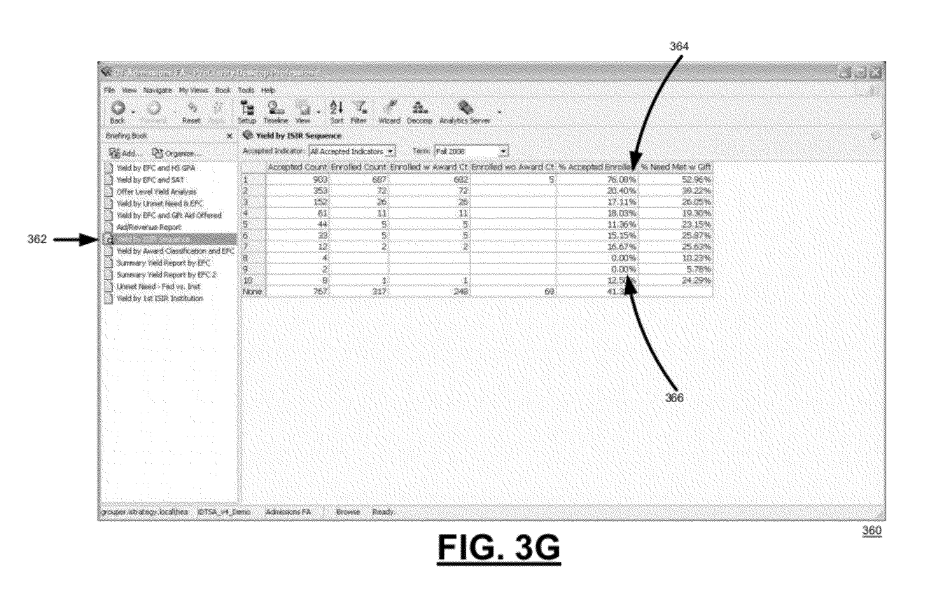

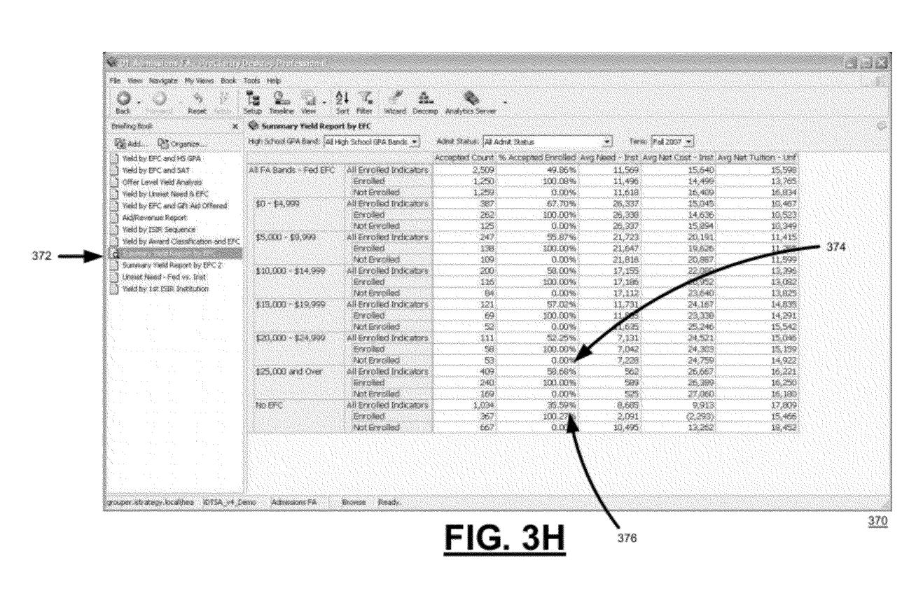

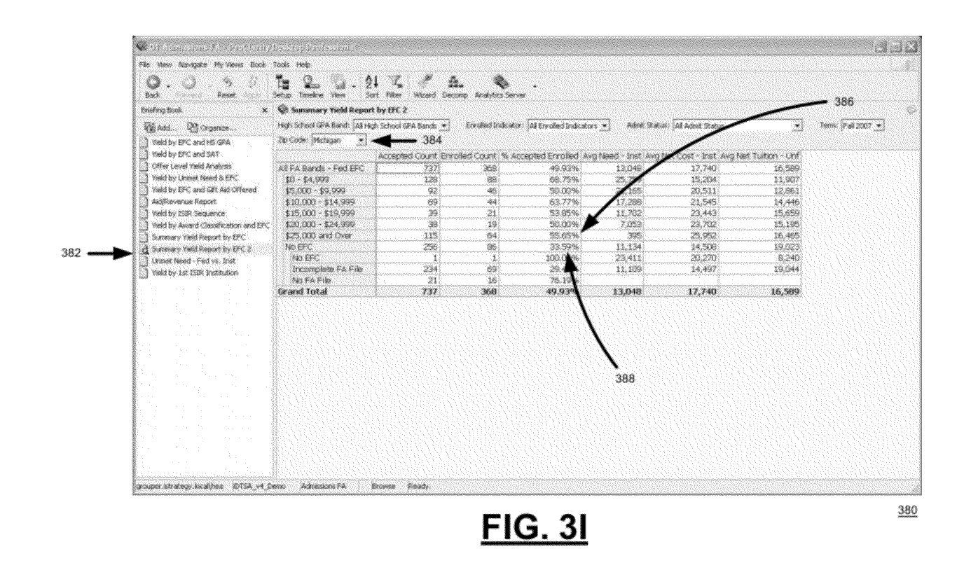

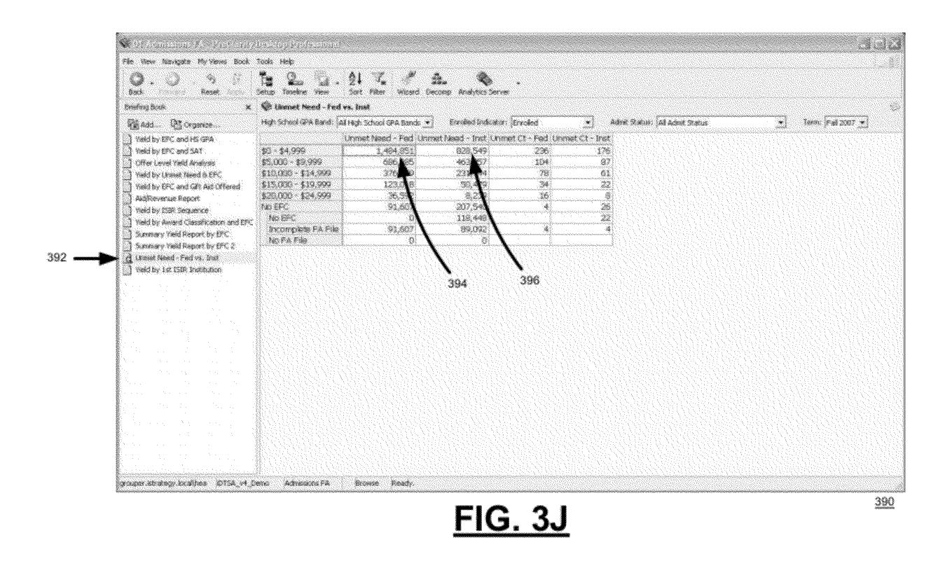

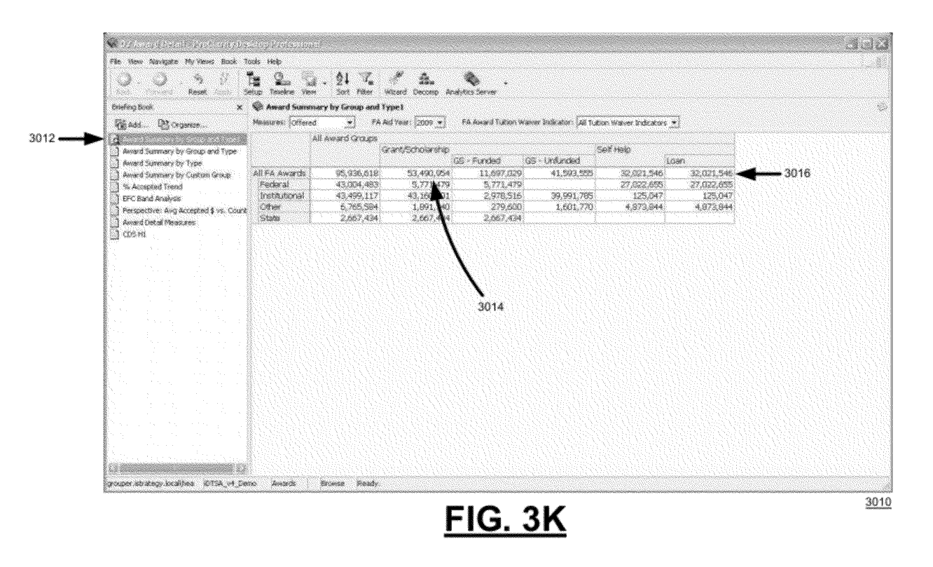

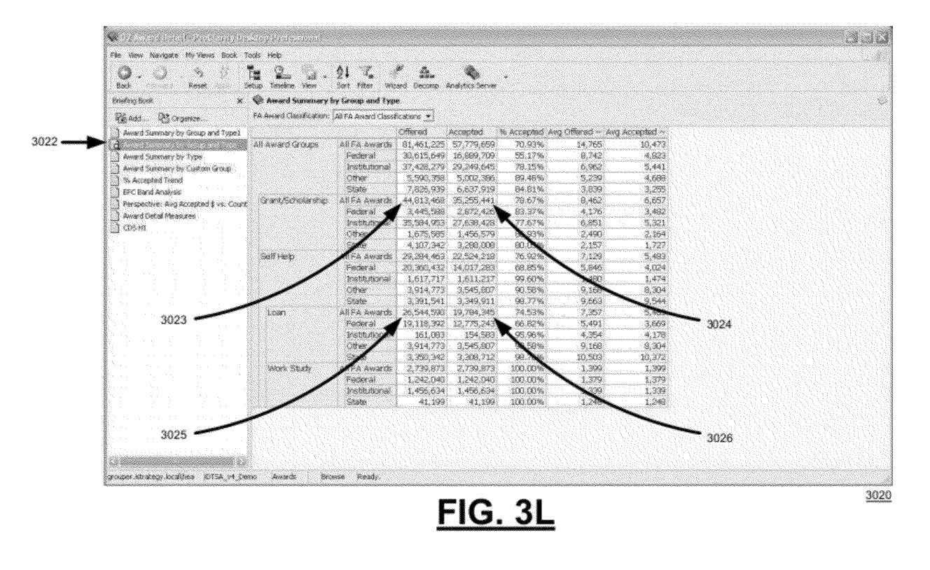

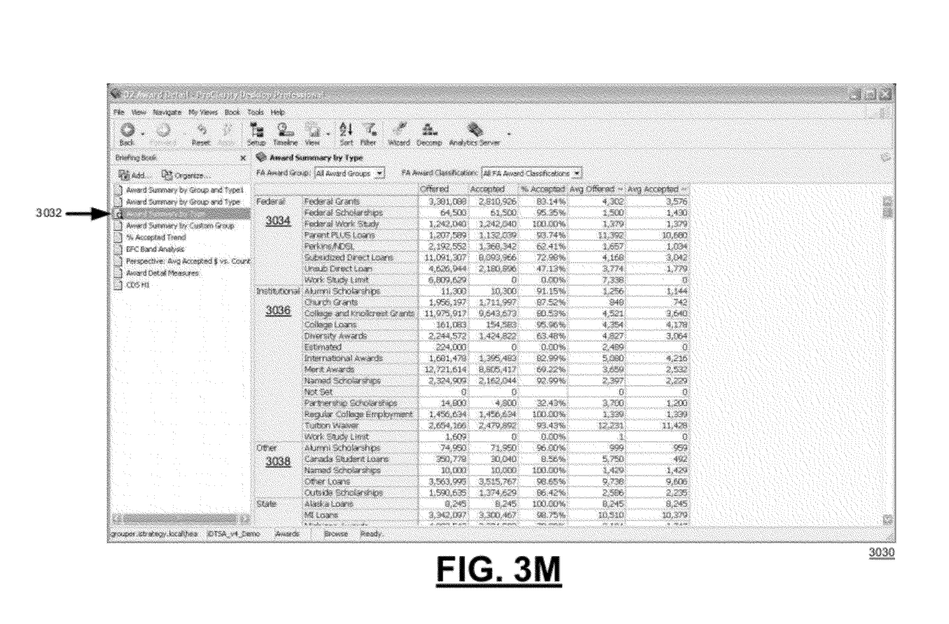

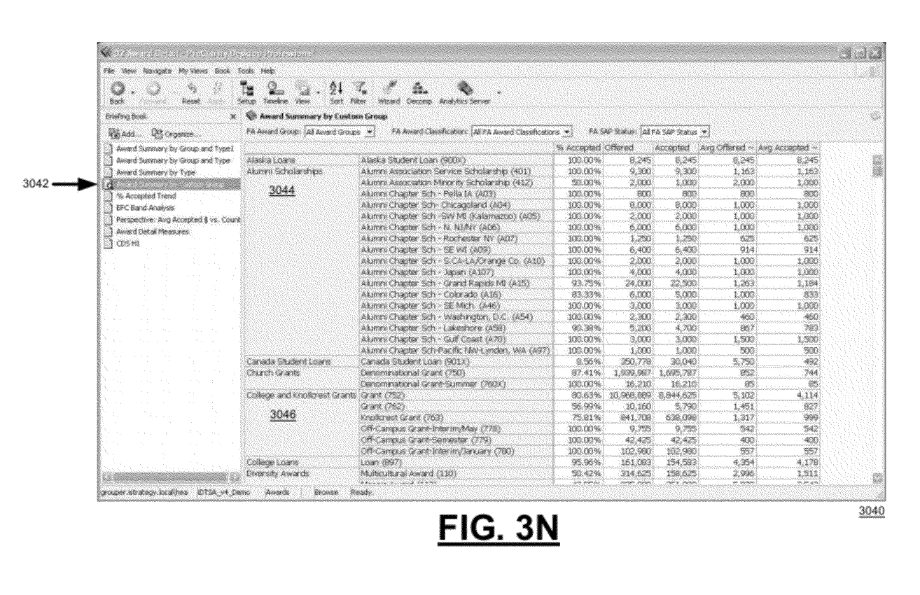

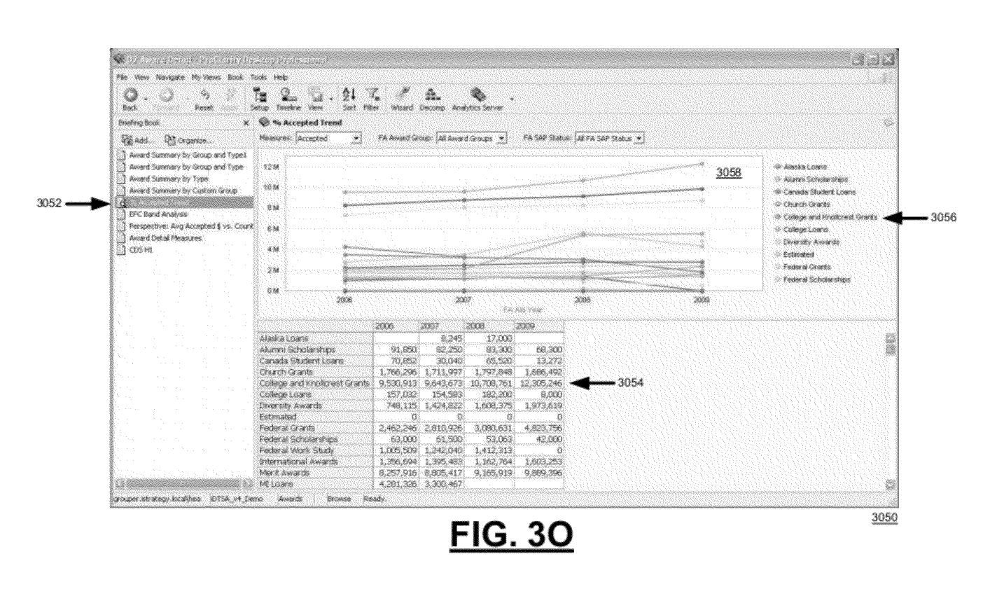

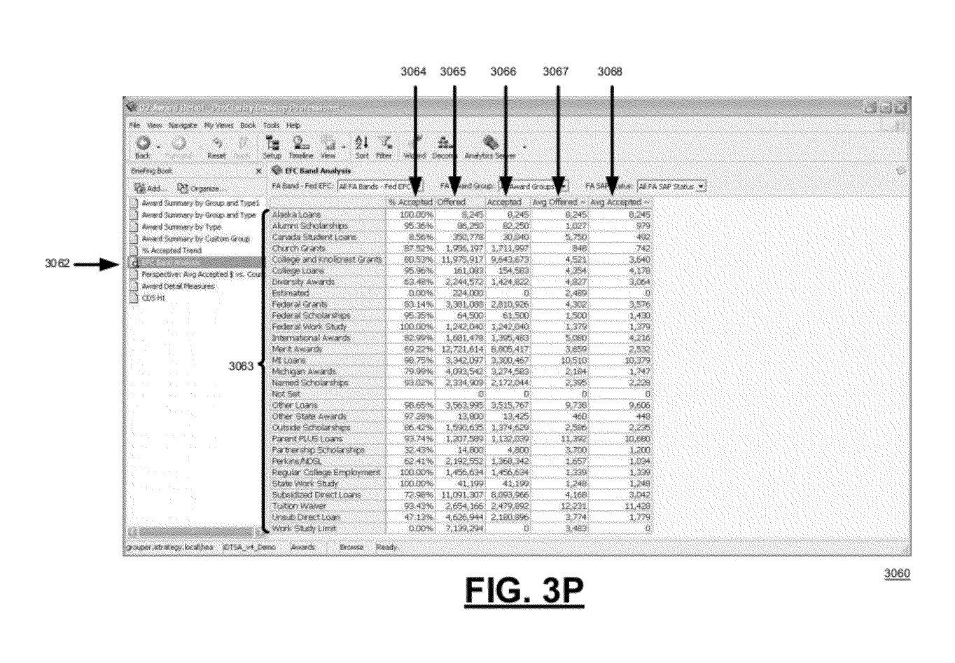

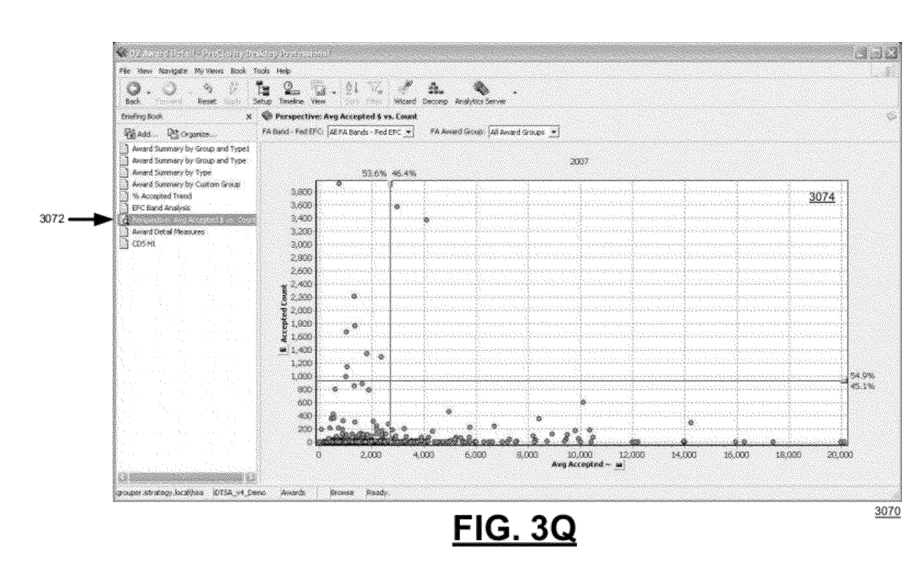

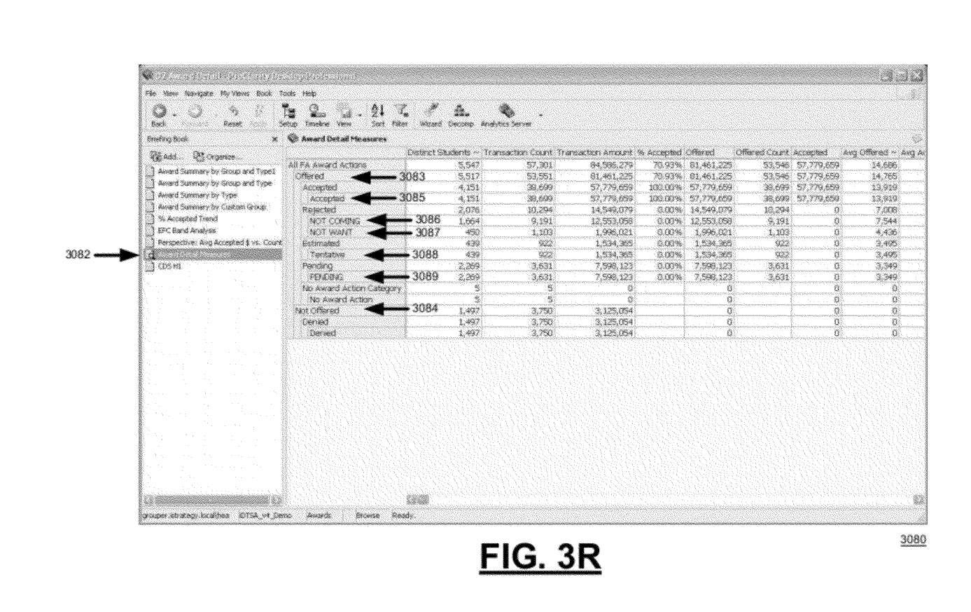

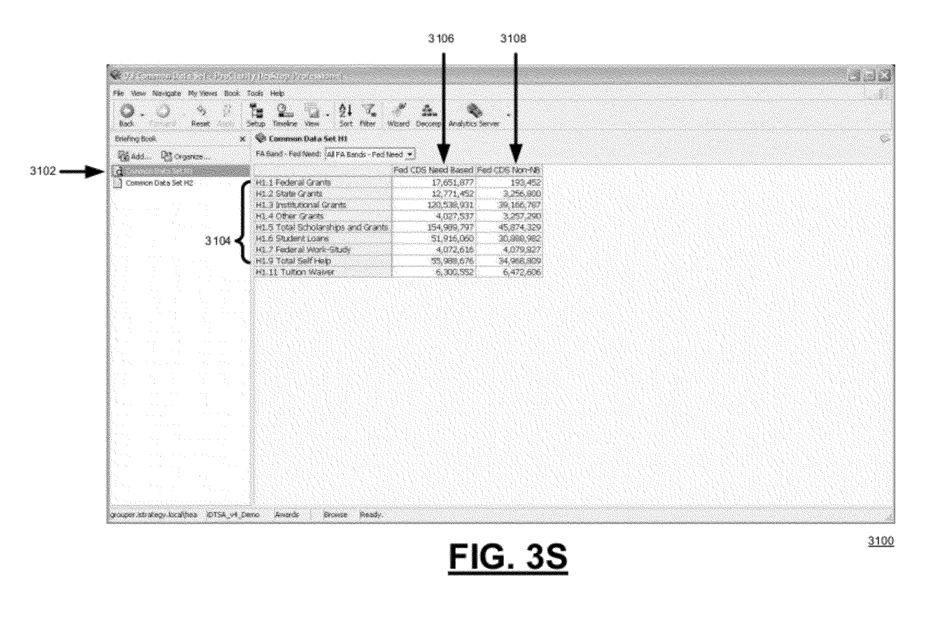

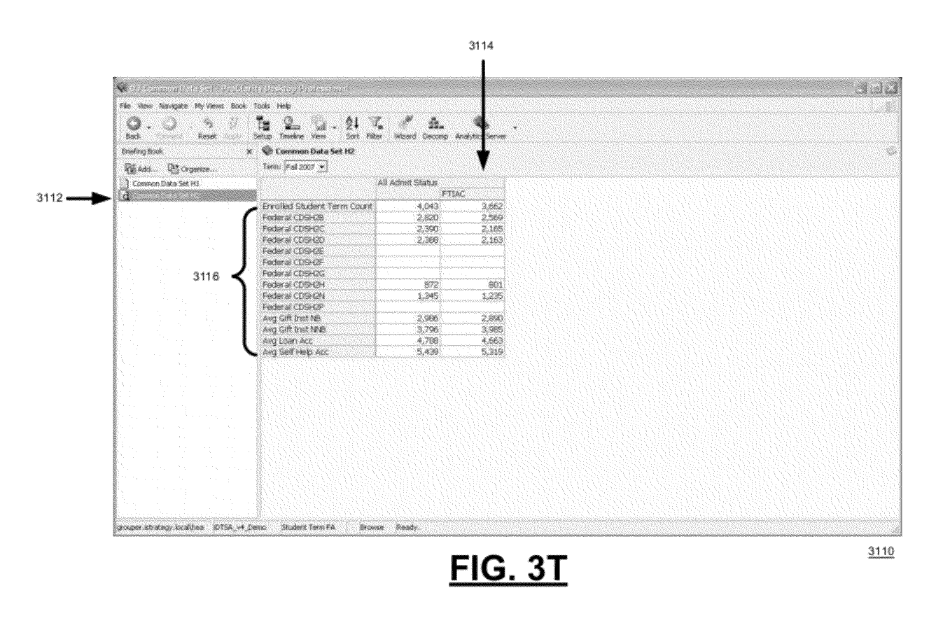

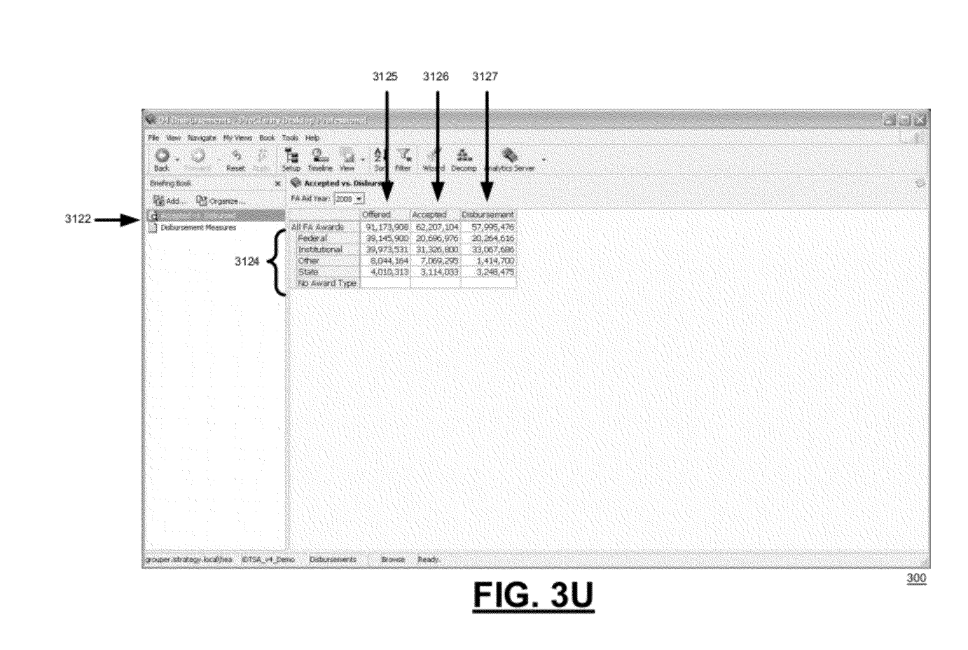

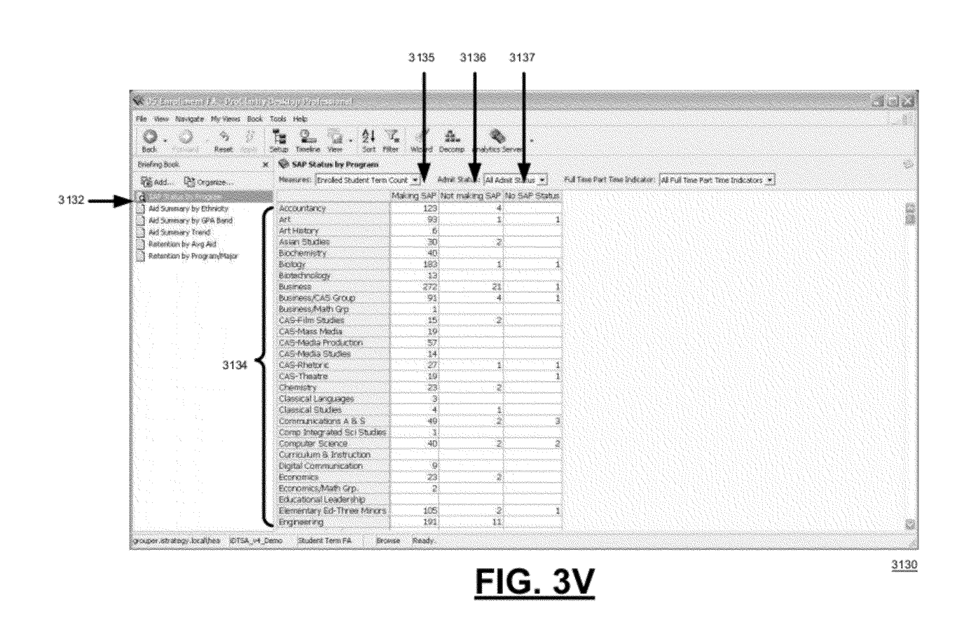

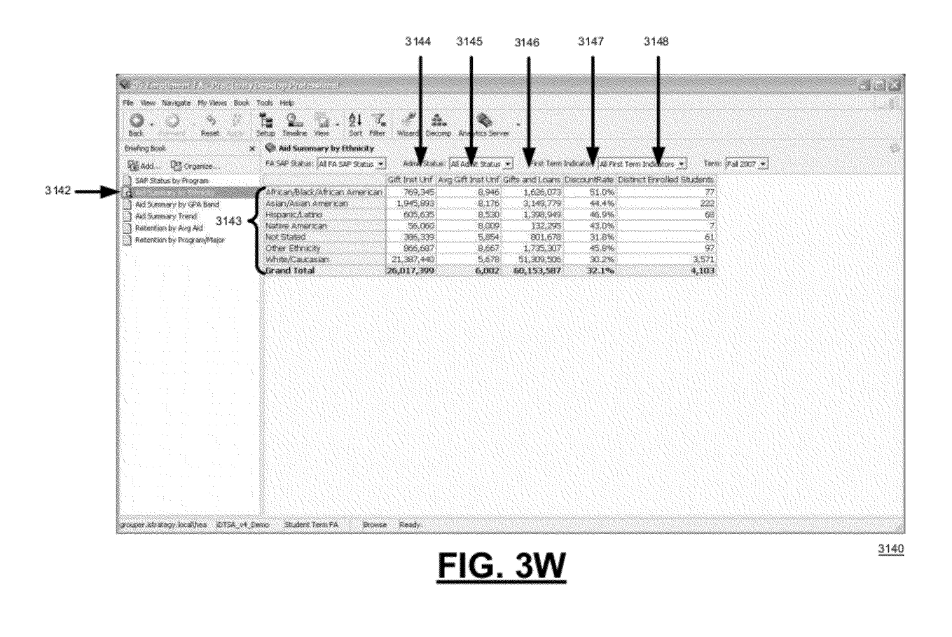

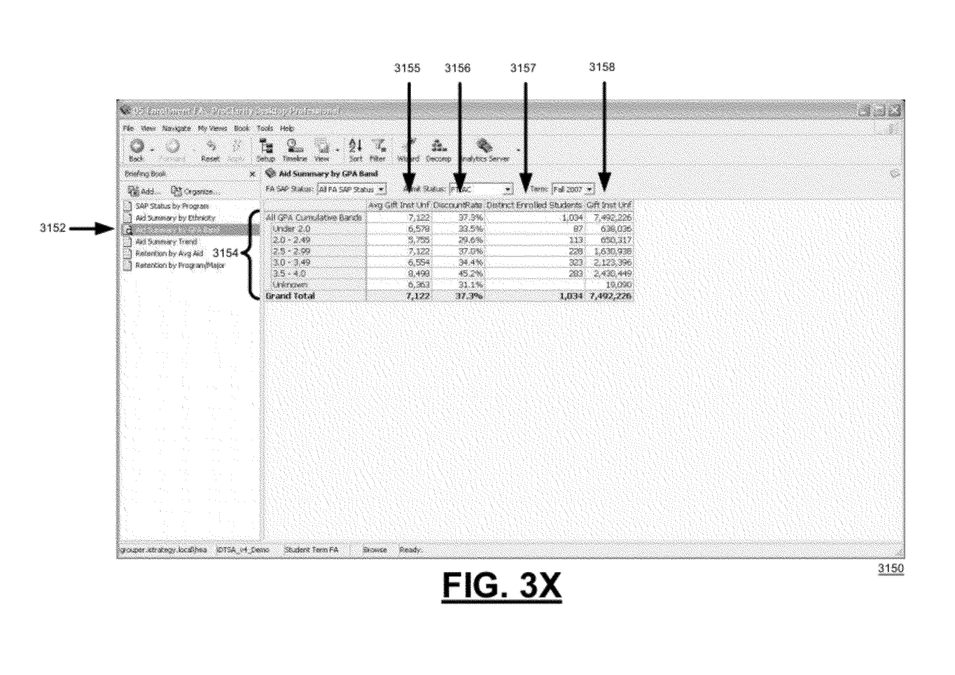

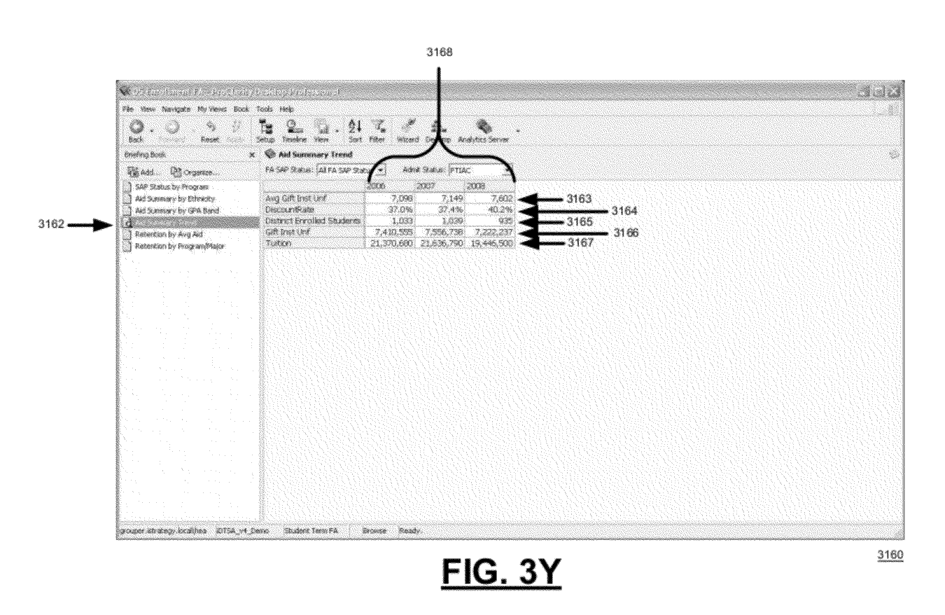

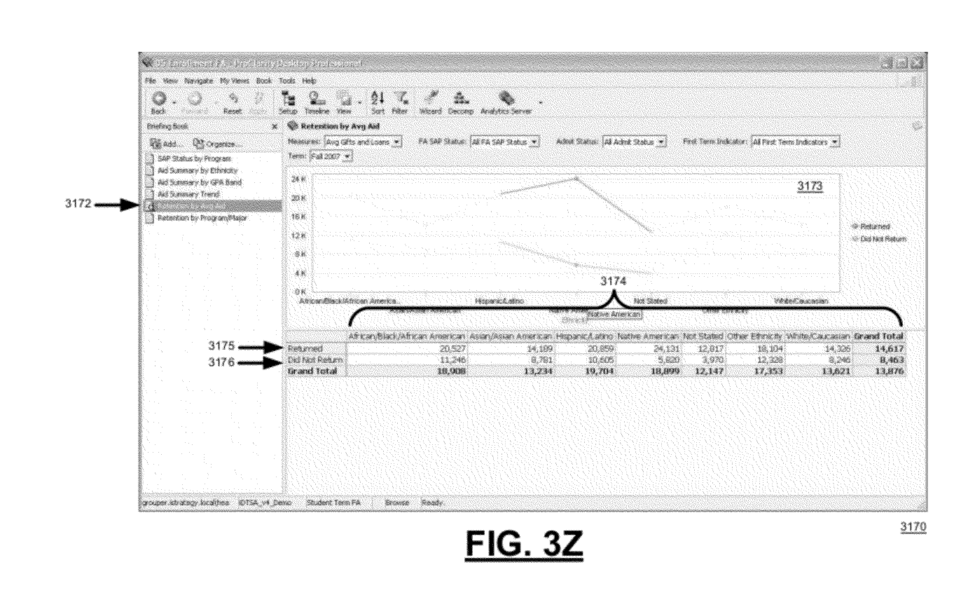

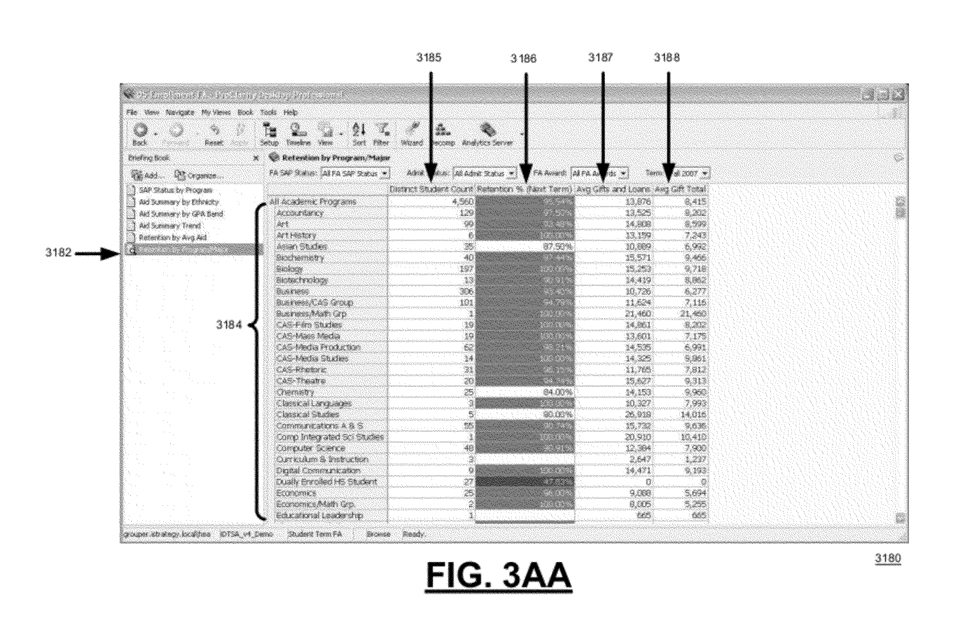

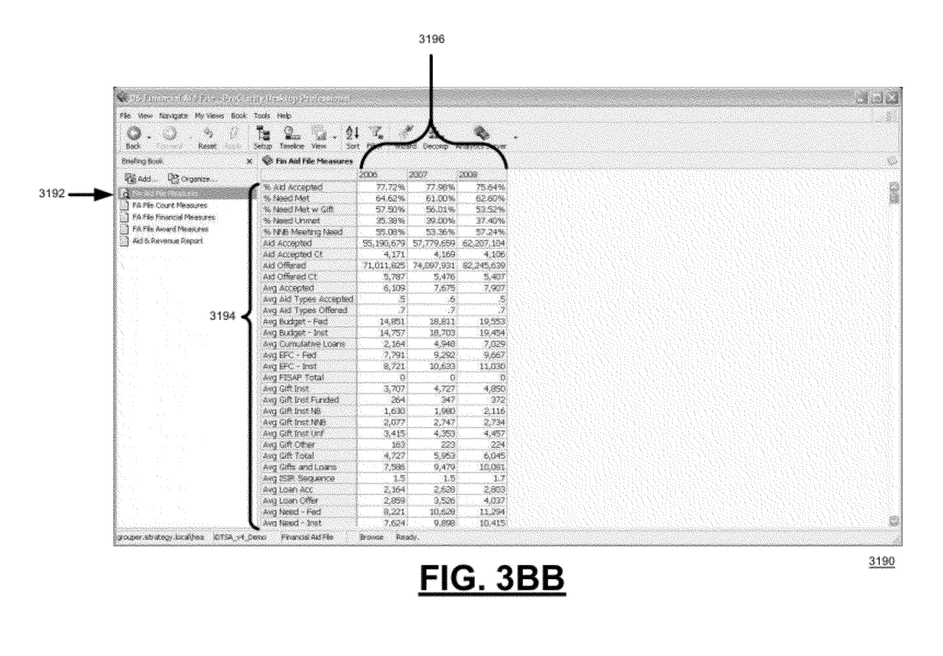

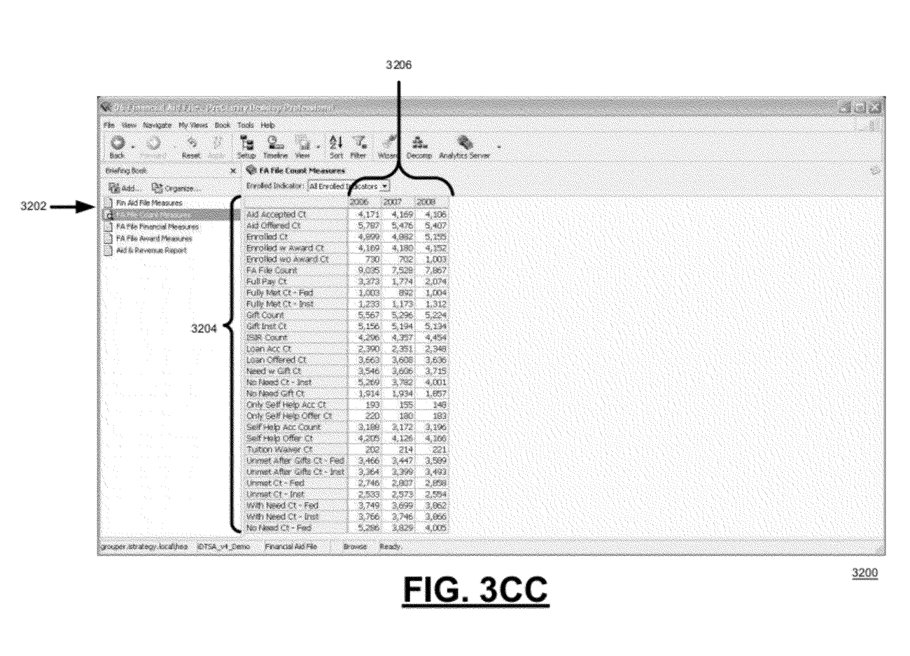

Having generated the analytics database 170, the processor 164 is configured to receive a first query for a report for the student data identified in the analytics database 170. The query, which can include user-specified parameters (e.g., selecting certain types of information to view in the report), can be received, for example, over the network 150 from a user of a client 110 (e.g., a desktop computer or a laptop computer) that enters the parameters for the query using an input device 116 (e.g., keyboard) at the client 110. The query can be received, for example, by the analytics module 172 using a web interface. In response to the query, the processor 164 of the analytics server 160 is configured to provide, to the user, the report for display on the display device 114 of the client 110. As will be discussed in further detail below with reference to FIGS. 3A-3FF, the report includes information identifying one or many relationships between: admissions data and enrollment data for a subset of the identified students; admissions data and financial aid data for a subset of the identified students; enrollment data and financial aid data for a subset of the identified students; or admissions data, enrollment data, and financial aid data for a subset of the identified students. For example, the report can include information on the likelihood of whether a selected group of students will enroll at an institution based on the financial aid received by those students. The user can view more details from the report using a second query, such as by clicking on certain information in the report to find out more detailed information (e.g., clicking on grant data to see the types of grants students were received). The report can be based on information attributes, such as start term, GPA band, whether the student returned in a next term, is seeking a degree, is enrolled, in a first term, the prior major of the student, or the student's term status. The report can also be based on metrics, such as admitted count, enrolled applicant count, the percentage of admitted students who enrolled, the planned major of the student, the class utilization rate, the retention rate, and the graduation rate.

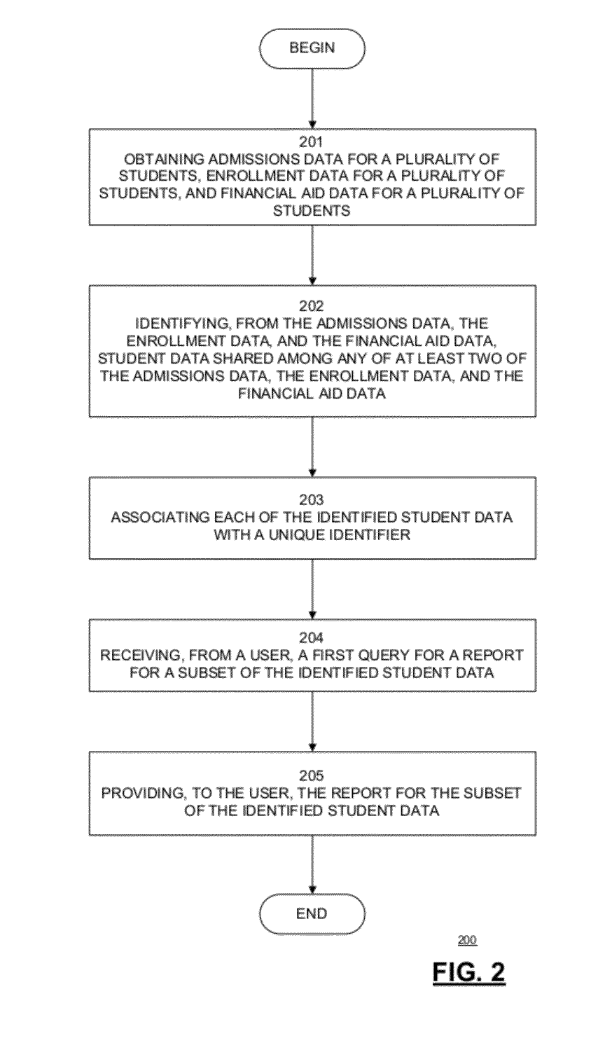

FIG. 2 is an exemplary process 200 for analytically combining student admissions data, enrollment data, and financial aid data to present relationships therein in accordance with the architecture of FIG. 1. The process 200 begins by proceeding to step 201, in which admissions data for a plurality of students from the admissions database 134, enrollment data for a plurality of students from the enrollment database 140, and financial aid data for a plurality of students from the financial aid data database 142 is obtained from the legacy server 130. Next, in step 202, student data shared among any of at least two of the admissions data, the enrollment data, and the financial aid data is identified. In step 203, each of the identified student data is associated with a unique identifier, and in step 204, a first query for a report for a subset of the identified student data is received from a user of the client 110. In step 205, the user is provided with the report for the subset of the identified student data. The report includes a relationship between any of at least two of admissions data for the subset of the identified student data, enrollment data for the subset of the identified student data, and financial aid data for the subset of the identified student data.

The exemplary process 200 of FIG. 2 analytically combines student admissions data, enrollment data, and financial aid data to present relationships therein in accordance with the architecture 100 of FIG. 1. An example will now be described using the exemplary process 200 of FIG. 2, and an exemplary university “Anytown University.” Anytown University stores its admissions data database 134, enrollment data database 140, and financial data database 142 on a legacy server 130. Anytown University, which has a limited amount of financial aid to offer, is seeking to improve, among various factors, its student acceptance rate (e.g., the rate at which students who are offered admission decide to enroll). Specifically, Anytown University would like to determine, for example, the likelihood of enrollment of an admitted student based on: the financial aid offered to the admitted student; estimated family contribution; academic performance; unmet financial needs; and the position in which the admitted student listed the Anytown University on a financial aid application. Anytown University would also like to determine an average amount of revenue generated from the attendance of each of its enrolled students, as well as the likelihood of an enrolled student continuing education at Anytown University based on the financial aid received by the identified students. Anytown University is unable to obtain this information from its pre-existing admissions data database 134, enrollment data database 140, and financial data database 142 because this information relies on relationships across the databases 134, 140, and 142.

Accordingly, Anytown University integrates an analytics module 172 as disclosed herein and provides the analytics server 160 with access to its legacy server 130 so that the analytics module 172 can provide Anytown University with the desired information. In step 201 of the process 200, the analytics server 160 obtains Anytown University's admissions data, enrollment data, and financial aid data from the respective databases 134, 140, and 142. Next, in step 202, the analytics server 160 identifies student data (e.g., common students, common applications, common academic information, etc.) shared among the admissions data, the enrollment data, and the financial aid data, as all students offered admission to Anytown University did not enroll, and all such students did not necessarily receive offers of financial aid from Anytown University. In step 203, each of the subset of identified student data is associated with a unique identifier generated by the analytics server 160. The analytics database 170 in the analytics server 160 is now stored in a format that facilitates the fast and efficient generation of custom analytics reports in accordance with the needs of Anytown University. Accordingly, an administrator at Anytown University submits a query for a custom report from his client to the analytics server 160, which in step 204, is received by the analytics module 172. In step 205, the custom report is provided to the administrator. The report, examples of which are illustrated in FIGS. 3A-3LL, shows various relationships between combinations of Anytown University's admissions data, enrollment data, and financial aid data for the subset of the identified student data. Specifically, the exemplary reports provide Anytown University with information on the likelihood of enrollment of admitted students (or selected group of admitted students, the group being selected by the user or pre-defined) based on: the financial aid offered to the admitted students; estimated family contribution; academic performance; unmet financial needs; and the position in which the admitted student listed the Anytown University on a financial aid application. The exemplary reports also provide Anytown University with information on an average amount of revenue generated from the attendance of each of its enrolled students, and the likelihood of an enrolled student continuing education at Anytown University based on the financial aid received by the identified students. The reports can be customized according to user parameters or generated based on a pre-defined query.

The exemplary report 300 of FIG. 3A illustrates the yield, by estimated family contribution (EFC) and GPA, of the percentage of admitted students (e.g., who received offers of admission from Anytown University) who enrolled at Anytown University 302. The yield illustrates a relationship between admissions data (e.g., GPA), financial aid data (e.g., EFC), and enrollment data. Specifically, the yield illustrates, for example, that among admitted students 304 having a GPA in the range of 3.0 to 3.49, only 33.33% of students who had no EFC 306 enrolled, while 74.74% of students who had a minimum amount of EFC 308, of $0 to $4,999, enrolled.

The exemplary report 310 of FIG. 3B illustrates the yield, by SAT score and GPA, of the percentage of admitted students who enrolled at Anytown University 312. The yield illustrates a relationship between admissions data (e.g., SAT score), financial aid data (e.g., EFC), and enrollment data. Specifically, the yield illustrates, for example, that among students 314 having an SAT score in the range of 1500 to 1600, all students having an EFC of $15,000 to $19,999 enrolled 316, while no more than 33.33% of the remaining students in the SAT score range of 1500 to 1600 enrolled 318.

The exemplary report 320 of FIG. 3C illustrates the yield, by financial aid offer among students having taken the SAT exam, of the percentage of admitted students who enrolled at Anytown University 322. The yield illustrates a relationship between admissions data (e.g., SAT score), financial aid data (e.g., financial aid offer amount) and enrollment data. Specifically, the yield illustrates, for example, that among students receiving a grant of at least $19,000 from Anytown University 324, at least 76.47% students enrolled regardless of their individual EFCs 326.

The exemplary report 330 of FIG. 3D illustrates the yield, by unmet need and EFC among student GPA bands, of the percentage of admitted students who enrolled at Anytown University 332. The yield illustrates a relationship between admissions data (e.g., GPA bands), financial aid data (e.g., unmet need, and EFC), and enrollment data. Specifically, the yield illustrates, for example, that among students 334 having no unmet need and an estimated family contribution below $19,999, at least 87.5% of students enrolled.

The exemplary report 340 of FIG. 3E illustrates the yield, by EFC and gift aid offered among students having taken the SAT exam, of the percentage of admitted students who enrolled at Anytown University 342. The yield illustrates a relationship between academic data (e.g., students having taken the SAT), financial aid data (e.g., EFC and gift aid offered), and enrollment data. Specifically, the yield illustrates, for example, that among students 344 having received gift aid from $18,000 to $31,999, most students enrolled at Anytown University regardless of EFC (with a few outliers). On the other hand, among students 346 who received gift aid below $7,000, most students did not enroll at Anytown University regardless of EFC.

The exemplary report 350 of FIG. 3F illustrates the yield, by gift aid offered among students having been admitted to Anytown University, of the percentage of admitted students who enrolled at Anytown University 352. The yield illustrates a relationship between financial aid data (e.g., EFC) and enrollment data. Specifically, the yield illustrates, for example, that among all students 354 having received an offer of admission, regardless of EFC, 49.86% students enrolled at Anytown University.

The exemplary report 360 of FIG. 3G illustrates the yield, by the position an admitted student listed Anytown University on his/her Institutional Student Information Record (ISIR), of the percentage of admitted students who enrolled at Anytown University 352. The yield illustrates a relationship between financial aid data (e.g., ISIR sequence) and enrollment data. The yield shows that the higher the position Anytown University is listed on the ISIR, the more likely an admitted student is to enroll at Anytown University. Specifically, the yield illustrates, for example, that 76.08% of students 364 who listed Anytown University first on their ISIR enrolled at Anytown University, while no student who listed Anytown University ninth on their ISIR enrolled at Anytown University.

The exemplary report 370 of FIG. 3H illustrates the yield, by EFC among students having been admitted to Anytown University, of the percentage of admitted students who enrolled at Anytown University 372. The yield illustrates a relationship between financial aid data (e.g., EFC) and enrollment data. Specifically, the yield illustrates, for example, that among admitted students 374 having an EFC of at least $25,000, 58.68% enrolled, while among admitted students 376 having no EFC, 35.59% enrolled at Anytown University.

The exemplary report 380 of FIG. 3I is a second query or more detailed report (e.g., limiting the report 370 of FIG. 3H to Michigan students) in view of the exemplary report 370 of FIG. 3H. The exemplary report 380 of FIG. 3I illustrates the yield, by EFC among Michigan students 384 having been admitted to Anytown University, of the percentage of admitted students who enrolled at Anytown University 382. The yield illustrates a relationship between financial aid data (e.g., EFC) and enrollment data. Specifically, the yield illustrates, for example, that among admitted Michigan students 386 having an EFC of at least $25,000, 55.65% enrolled, while among admitted Michigan students 388 having no EFC, 33.59% enrolled at Anytown University.

The exemplary report 390 of FIG. 3J illustrates the yield, by EFC among enrolled students having GPA data, of the amount of federal or institutional unmet need. The yield illustrates a relationship between admissions data (e.g., GPA data), financial aid data (e.g., EFC and unmet need), and enrollment data. Specifically, the yield illustrates, for example, that among admitted students having an EFC of less than $5,000, there was a federal unmet need 394 of $1,484,851 and an institutional unmet need 396 of $828,549.

The exemplary report 3010 of FIG. 3K illustrates the yield, by financial aid award among admitted students, of the amount of financial aid taken. The yield illustrates a relationship between financial aid data (e.g., financial aid award) and enrollment data. Specifically, the yield illustrates, for example, that $53,490,954 was offered to admitted students in grants and scholarships 3014, while $32,021,546 was taken in loans 3016 by admitted students.

The exemplary report 3020 of FIG. 3L is a second query or more detailed report in view of the exemplary report 3010 of FIG. 3K because, for example, it differentiates between admitted students and enrolled students. The exemplary report 3020 of FIG. 3L illustrates a yield, by financial aid award among admitted students and enrolled students, of the amount of financial aid taken. The yield illustrates a relationship between financial aid data (e.g., financial aid award) and enrollment data. Specifically, the yield illustrates, for example, that $44,813,468 was offered to admitted students in grants and scholarships 3023, while $$35,255,441 was offered to enrolled students in grants and scholarships 3024. The yield also illustrates that $26,544,590 was taken in loans by admitted students 3025, while $19,784,345 was taken in loans by enrolled students 3026.

The exemplary report 3030 of FIG. 3M is another second query or more detailed report in view of the exemplary report 3010 of FIG. 3K because, for example, it provides information on the awards by the types of award given. The exemplary report 3030 of FIG. 3M illustrates a breakdown by financial aid award type and amount taken among admitted students and enrolled students. The yield illustrates a relationship between financial aid data (e.g., financial aid award amount and type) and enrollment data. Specifically, the yield illustrates, for example, detailed information on different types of federal awards 3034, detailed information on different types of institutional awards 3036, and detailed information on different types of other awards 3038.

The exemplary report 3040 of FIG. 3N is another second query, a custom report in view of the exemplary report 3010 of FIG. 3K. The exemplary, custom report 3040 of FIG. 3N illustrates a more detailed breakdown by financial aid award type among admitted students and enrolled students. The yield illustrates a relationship between financial aid data (e.g., financial aid award type) and enrollment data. Specifically, the yield illustrates, for example, detailed information on different types of alumni scholarships 3044 and detailed information on different types of college and Knollcrest grants 3046.

The exemplary report 3050 of FIG. 3O illustrates a trend 3052 of accepted students and amount in award grants from 2006 and 2009. The line graph illustrates a relationship between financial aid data (e.g., financial aid type, amount, and year) and enrollment data. Specifically, the yield illustrates, for example, the amount 3054 given in College and Knollcrest Grants from 2006 to 2009, and a line graph illustrating the trend 3058 in the amount given in College and Knollcrest Grants from 2006 to 2009 using a key identification 3056.

The exemplary report 3060 of FIG. 3P illustrates an EFC band analysis 3062. The report 3060 illustrates a relationship between financial aid data (e.g., financial aid type and amount) and enrollment data. Specifically, the report 3060 illustrates, for example, for each type of financial aid 3063: the percentage of financial aid money accepted 3064, the amount offered 3065, the amount accepted 3066, and the average amount offered 3067.

The exemplary report 3070 of FIG. 3Q illustrates a perspective of the average amount of financial aid money accepted versus the number of students accepted 3072. The report 3070 illustrates a relationship between financial aid data (e.g., financial aid amount) and enrollment data. Specifically, the report 3070 illustrates a perspective chart 3074 that illustrates the average amount of financial aid money accepted in 2007 versus the number of students accepted.

The exemplary report 3080 of FIG. 3R illustrates award detail measures 3082. The report 3070 illustrates a relationship between financial aid data (e.g., financial aid offer status) and enrollment data. Specifically, the report 3080 illustrates a numerical breakdown, in columns, of students who have been offered 3083 financial aid and students who have not been offered 3084 financial aid. Of the students who have been offered 3083 financial aid, the current status, e.g., accepted 3085, not coming 3086 to Anytown University, not wanting 3087 financial aid, tentatively accepting 3088 financial aid, and pending acceptance 3089 of financial aid are further detailed.

The exemplary report 3100 of FIG. 3S illustrates a common data set of financial aid information 3102. The report 3100 illustrates the amounts of need based 3106 and non-need based 3108 aid for various types 3104 of financial aid. The exemplary report 3110 of FIG. 3T also illustrates a more detailed common data set 3112 of financial aid information known as the Common Data Set H2 report. This report provides the total count of enrolled degree seeking students and various financial aid metrics related to the overall population of degree seeking student. The report 3110 illustrates various details associated with admitted students 3116, including a count of first time students in any college (FTIAC) 3114.

The exemplary report 3120 of FIG. 3U illustrates a comparison of accepted financial aid versus disbursed financial aid 3122. The report 3120 illustrates a comparison, of various types of financial aid 3124, of offered financial aid 3125, accepted financial aid 3126, and disbursed financial aid 3127. The exemplary report 3130 of FIG. 3V illustrates a listing of satisfactory academic status (SAP) by program 3132. The report 3130 illustrates a listing, by program 3134, of enrolled students making SAP 3135, not making SAP 3136, or not having an SAP status 3137.

The exemplary report 3140 of FIG. 3W illustrates a financial aid summary by ethnicity 3142. The report 3140 provides a listing, by program ethnicity 3143, of total amount of institutional gift aid 3144, average institutional gift aid per student 3145, gifts and loans 3146, the rate by which attendance has been discounted due to gifts and loans 3147, and the number of enrolled students 3148.

The exemplary report 3150 of FIG. 3X illustrates a financial aid summary by GPA band 3152. The report 3150 provides a listing, by GPA band 3154, of average institutional gift aid per student 3155, the rate by which attendance has been discounted due to gift aid 3156, the number of enrolled students 3157, and the total amount of institutional gift aid 3158.

The exemplary report 3160 of FIG. 3Y illustrates a financial aid summary trend 3162. The report 3160 provides a listing, by year 3168, of average institutional gift aid per student 3163, the rate by which attendance has been discounted due to gift aid 3164, the number of enrolled students 3165, the total amount of institutional gift aid 3166, and the total amount of tuition 3167.

The exemplary report 3170 of FIG. 3Z illustrates retention of students by average aid given 3172. The report 3170 provides a listing, by ethnicity 3174, of the average amount of financial aid received by students who returned 3175 to Anytown University and by students who did not return 3176 to Anytown University. The report 3170 also provides a graphic illustration 3173 of the information. The exemplary report 3180 of FIG. 3AA illustrates retention of students by program/major 3182. The report 3180 provides a listing, by program/major 3184, of the number of students 3185, retention rate 3186, average institutional gift and loan aid per student 3187, and the total average gift aid 3188.

The exemplary report 3190 of FIG. 3BB illustrates financial aid file measures 3192. Specifically, the report 3190 provides a listing, by year 3196, of various specific financial aid file measures 3194. The exemplary report 3200 of FIG. 3CC illustrates financial aid file count measures 3202. Specifically, the report 3200 provides a listing, by year 3206, of various specific financial aid file count measures 3204. The exemplary report 3210 of FIG. 3DD illustrates financial measures for financial aid files 3212. Specifically, the report 3210 provides a listing, by year 3216, of various specific financial measures for financial aid files 3214. The exemplary report 3220 of FIG. 3EE illustrates financial aid file award measures 3222. Specifically, the report 3220 provides a listing, by year 3226, of various specific financial aid file award measures 3224.

The exemplary report 3230 of FIG. 3FF illustrates information on aid and revenue 3232. Specifically, the report 3230 provides a listing, by EFC band 3231, of information such as financial aid file count 3233, average student need 3234, average unfunded institutional gift per student 3235, average funded institutional gift per student 3236, average institutional gift per student 3237, average state and federal grants per student 3238, and average other financial gift per student 3239.

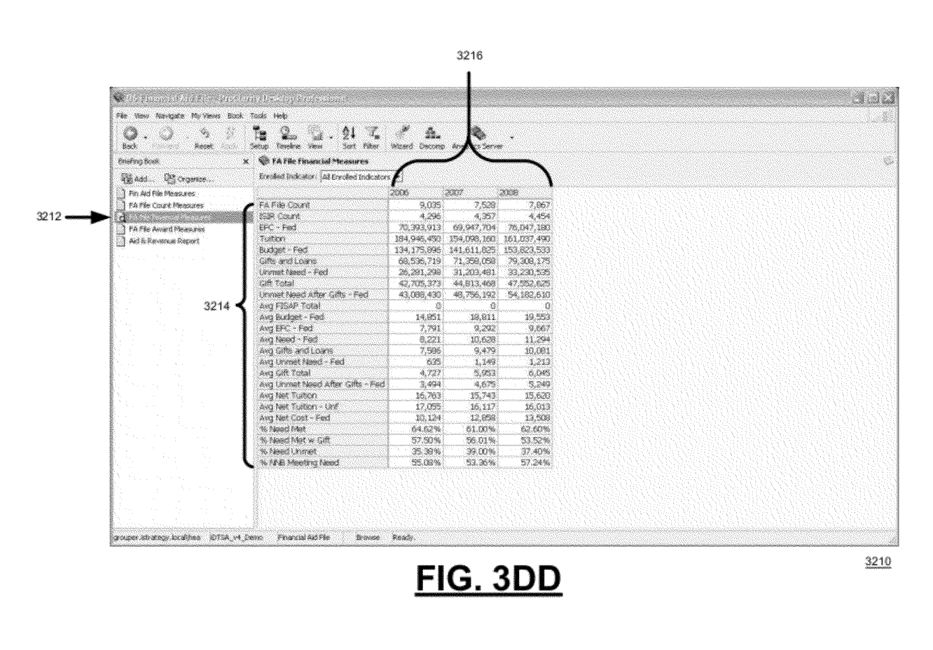

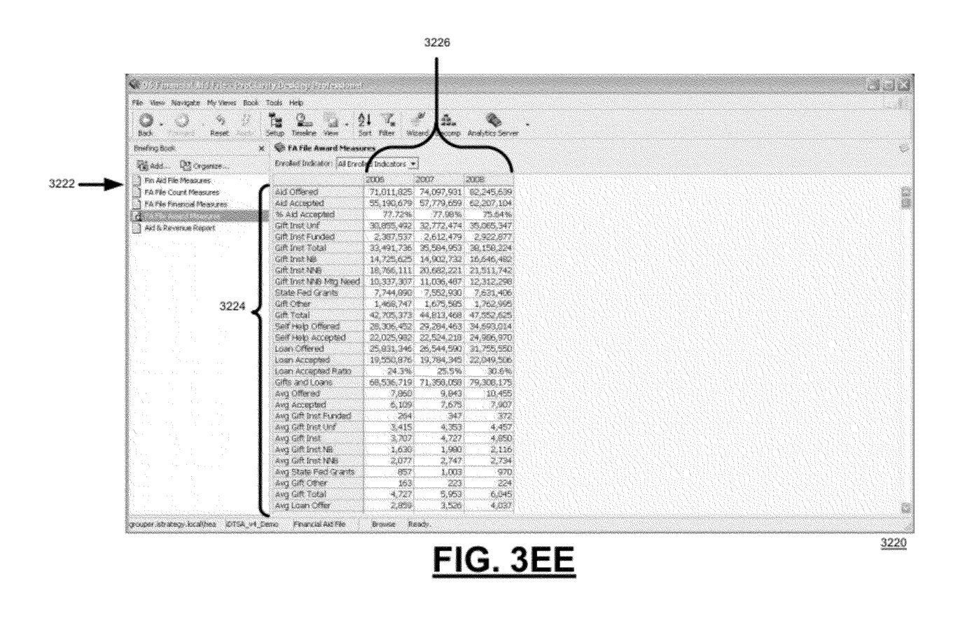

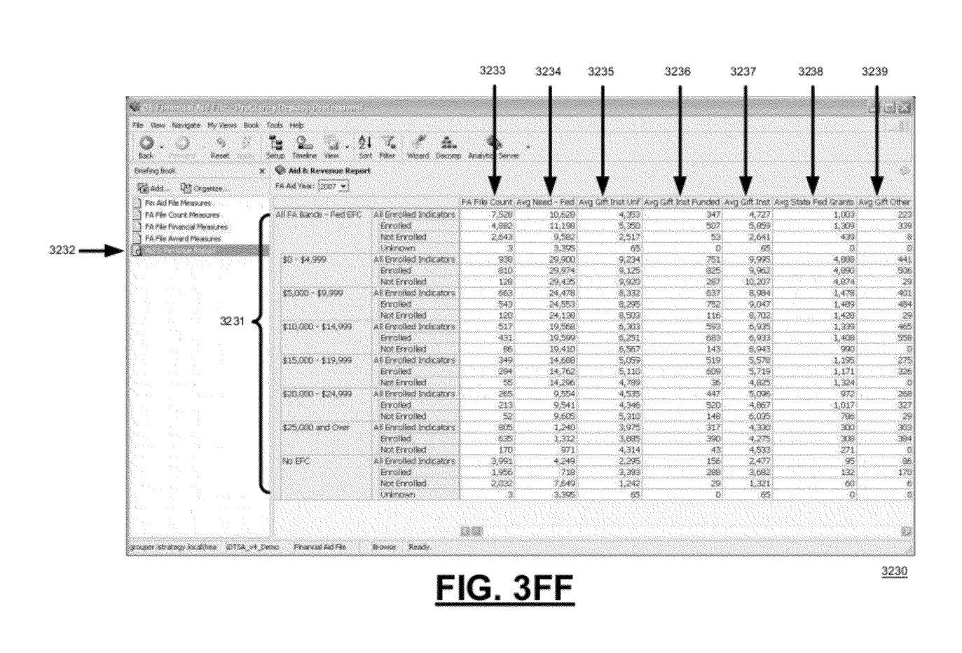

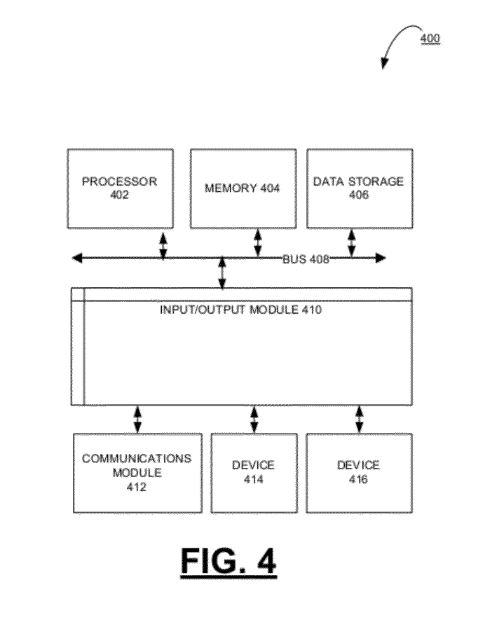

FIG. 4 is a block diagram illustrating an exemplary computer system 400 with which the client 110 and servers 130 and 160 of FIG. 1 can be implemented. In certain aspects, the computer system 400 may be implemented using hardware or a combination of software and hardware, either in a dedicated server, or integrated into another entity, or distributed across multiple entities.

Computer system 400 (e.g., client 110 and server 130 and 160) includes a bus 408 or other communication mechanism for communicating information, and a processor 402 (e.g., processor 112, 136, and 164) coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404 (e.g., memory 120, 132, and 162), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, i.e., one or more modules of computer program instructions encoded on a computer readable medium for execution by, or to control the operation of, the computer system 400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices (e.g., device 414 and 416). The input/output module 410 can be any input/output module. Exemplary input/output modules 410 include data ports such as USB ports. The input/output module 410 is configured to connect to a communications module 412 (e.g., communications modules 118, 138, and 168). Exemplary communications modules 412 include networking interface cards, such as Ethernet cards and modems. In certain aspects, the input/output module 410 is configured to connect to a plurality of devices, such as an input device 414 (e.g., input device 116) and/or an output device 416 (e.g., display device 114). Exemplary input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 416 include display devices, such as a CRT (cathode ray tube) or LCD (liquid crystal display) monitor, for displaying information to the user.

According to one aspect of the present disclosure, the client 110 and server 130 and 160 can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network and a wide area network.

Computing system 400 can include clients and servers. A client and server are generally remote from each other and typically interact through a communication network (e.g., network 150). The communication network can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The relationship of client and server arises by virtue of computer programs running on the respective computers and having a client-server relationship to each other. Computer system 400 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

An analytics system for identifying relationships between admissions data, financial aid data, and enrollment data for institutions is disclosed. The system identifies common students between disparate databases for admissions data, financial aid data, and enrollment data, and generates a single analytics database to facilitate the identification of relationships between the data including, for example, the relationship of whether a student is likely to enroll at an institution based on the amount of financial aid offered to the student by the institution.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

What is claimed is:

1. A system for analytically combining student admissions data, enrollment data, and financial aid data to present relationships therein, comprising:
a memory comprising:
a first database storing admissions data for a plurality of students;
a second database storing enrollment data for a plurality of students; and
a third database storing financial aid data for a plurality of students; and
a processor configured to:
obtain the admissions data, the enrollment data, and the financial aid data;
identify, from the admissions data, the enrollment data, and the financial aid data, student data shared among any of at least two of the admissions data, the enrollment data, and the financial aid data;
associate each of the identified student data with a unique identifier;
receive, from a user, a first query for a report for a subset of the identified student data; and
provide, to the user, the report for the subset of the identified student data,
wherein the report is generated by detecting at least two of admissions data, enrollment data, and financial aid data for the subset of the identified student data using the unique identifiers associated with the subset of the identified student data, and
wherein the report comprises a relationship between any of at least two of admissions data for the subset of the identified student data, enrollment data for the subset of the identified student data, and financial aid data for the subset of the identified student data.

2. The system of claim 1, wherein the identified student data comprises students identified as shared among any of at least two of the admissions data, the enrollment data, and the financial aid data, and wherein the report comprises an indication of the likelihood of enrollment of the subset of the identified students at the institution based on the financial aid offered to the subset of the identified students.

3. The system of claim 1, wherein the identified student data comprises students identified as shared among any of at least two of the admissions data, the enrollment data, and the financial aid data, and wherein the report comprises an indication of the likelihood of enrollment of the subset of the identified students at the institution based on at least one of the estimated average family contribution received by the subset of the identified students, the academic performance of the subset of the identified students, and the unmet financial needs of the subset of the identified students.

4. The system of claim 1, wherein the identified student data comprises students identified as shared among any of at least two of the admissions data, the enrollment data, and the financial aid data, and wherein the report comprises an indication of the likelihood of enrollment of the subset of the identified students at the institution based on the position in which the subset of the identified students listed the institution on a financial aid application.

5. The system of claim 1, wherein the identified student data comprises students identified as shared among any of at least two of the admissions data, the enrollment data, and the financial aid data, and wherein the report comprises an average amount of revenue generated from the attendance of the subset of the identified students at the institution.

6. The system of claim 1, wherein the identified student data comprises students identified as shared among any of at least two of the admissions data, the enrollment data, and the financial aid data, and wherein the report comprises an indication of the likelihood of continued enrollment of the subset of the identified students at the institution based on the financial aid received by the subset of the identified students.

7. The system of claim 1, wherein the identified student data comprises students identified as shared among any of at least two of the admissions data, the enrollment data, and the financial aid data, and wherein the processor is further configured to:
obtain, from the admissions data, academic performance data for each of the identified students, wherein the academic performance data for a first subset of the identified students is associated with a first academic performance standard and the academic performance data for a second subset of the identified students is associated with a second academic performance standard;
generate, based on the number of the identified students, the academic performance data for the first subset, and the academic performance data for the second subset, a new academic performance standard;
standardize, using the new academic performance standard, the academic performance data for each of the identified students into standardized academic performance data; and
combine, using the unique identifier of each of the identified students, the standardized academic performance data, the enrollment data, and the financial aid data into an analytics database,
wherein the responsive financial aid information for the identified students further comprises information from the analytics database.

8. The system of claim 7, wherein the processor is configured to generate the new academic performance standard by:
dividing the first subset of the identified students into a first set of a predetermined number of ordered groups based on the performance of each of the identified students in the first subset according to the first academic performance standard;
dividing the second subset of the identified students into a second set of the predetermined number of ordered groups based on the performance of each of the identified students in the second subset according to the second academic performance standard; and
associating the ranking of each of the respective ordered groups from the first set with the corresponding group from the second set.

9. The system of claim 8, wherein the processor is configured to standardize the academic performance data for each of the identified students into standardized academic performance data by ranking each of the identified students according to their respective ordered group.

10. The system of claim 9,
wherein the obtained academic performance data for the first subset and the second subset comprises a shared academic standard,
wherein the processor is further configured to generate the new academic performance standard by:
dividing the identified students into a third set of the predetermined number of ordered groups based on the performance of each of the identified students according to the shared academic standard; and
associating the ranking of each of the respective ordered groups from the third set with the corresponding groups from the first set and the second set; and
wherein the processor is further configured to standardize the academic performance data for each of the identified students into standardized academic performance data by:
assigning a first numeric value to each of the identified students from the first subset according to their respective ordered group from the first set;
assigning a second numeric value to each of the identified students from the second subset according to their respective ordered group from the second set;
assigning a third numeric value to each of the identified students according to their respective ordered group from the third set;
summing the numeric values associated with each of the identified students; and
ranking each of the identified students according to their associated sum value.

11. The system of claim 10,
wherein the shared academic standard is a grade point average, the first academic performance standard is a first standardized test, and the second academic performance standard is a second standardized test, and
wherein the assigned numeric values begin with 1.

12. The system of claim 1, wherein the first query comprises a plurality of parameters specified by the user, and wherein the first query is pre-defined by the user based on the specified plurality of parameters.

13. The system of claim 1, wherein the first query comprises a first parameter specified by the user, wherein the report is further based on the first parameter, and wherein the processor is further configured to:
receive, from the user, a second query in response to the report, the second query comprising the first parameter and a second parameter; and
provide, to the user, another report for the identified student data in response to the second query, wherein the other report is based on the first parameter and the second parameter, and comprises a relationship between any of at least two of admissions data for the identified student data, enrollment data for the identified student data, and financial aid data for the identified student data.

14. The system of claim 1,
wherein the enrollment data comprises degree award information and academic performance information for the institution, and
wherein the subset of the identified student data comprises students that have graduated from the institution, and
wherein the responsive financial aid information comprises financial aid information, academic performance information, and degree award information for the graduated students.

15. The system of claim 1, wherein the processor is further configured to:
receive, from the user, a second query in response to the responsive financial aid information; and
provide, to the user, a response to the second query comprising additional information for the subset of the identified student data associated with the responsive financial aid information, wherein the additional information comprises enumerated numerical data associated with the responsive financial aid information.

16. The system of claim 1, wherein the first database, the second database, and the third database are portions of a single database.

17. A method for analytically combining student admissions data, enrollment data, and financial aid data to present relationships therein, comprising:
obtaining admissions data from an admissions database for a plurality of students, enrollment data from an enrollment database for a plurality of students, and financial aid data from a financial aid database for a plurality of students;
identifying, from the admissions data, the enrollment data, and the financial aid data, students shared among any of at least two of the admissions data, the enrollment data, and the financial aid data;
associating each of the identified student data with a unique identifier;
receiving, from a user, a first query for a report for a subset of the identified student data; and
providing, to the user, the report for the subset of the identified student data,
wherein the report is generated by detecting at least two of admissions data, enrollment data, and financial aid data for the subset of the identified student data using the unique identifiers associated with the subset of the identified student data, and
wherein the report comprises a relationship between any of at least two of admissions data for the subset of the identified student data, enrollment data for the subset of the identified student data, and financial aid data for the subset of the identified student data.

18. The method of claim 17, wherein the identified student data comprises students identified as shared among any of at least two of the admissions data, the enrollment data, and the financial aid data, and wherein the report comprises an indication of the likelihood of enrollment of the subset of the identified students at the institution based on the financial aid offered to the subset of the identified students.

19. The method of claim 17, wherein the identified student data comprises students identified as shared among any of at least two of the admissions data, the enrollment data, and the financial aid data, and wherein the report comprises an indication of the likelihood of enrollment of the subset of the identified students at the institution based on at least one of the estimated average family contribution received by the subset of the identified students, the academic performance of the subset of the identified students, and the unmet financial needs of the subset of the identified students.

20. The method of claim 17, wherein the identified student data comprises students identified as shared among any of at least two of the admissions data, the enrollment data, and the financial aid data, and wherein the report comprises an indication of the likelihood of enrollment of the subset of the identified students at the institution based on the position in which the subset of the identified students listed the institution on a financial aid application.

21. The method of claim 17, wherein the identified student data comprises students identified as shared among any of at least two of the admissions data, the enrollment data, and the financial aid data, and wherein the report comprises an average amount of revenue generated from the attendance of the subset of the identified students at the institution.

22. The method of claim 17, wherein the identified student data comprises students identified as shared among any of at least two of the admissions data, the enrollment data, and the financial aid data, and wherein the report comprises an indication of the likelihood of continued enrollment of the subset of the identified students at the institution based on the financial aid received by the subset of the identified students.

23. The method of claim 17, wherein the identified student data comprises students identified as shared among any of at least two of the admissions data, the enrollment data, and the financial aid data, and the method further comprising:
obtaining, from the admissions data, academic performance data for each of the identified students, wherein the academic performance data for a first subset of the identified students is associated with a first academic performance standard and the academic performance data for a second subset of the identified students is associated with a second academic performance standard;
generating, based on the number of the identified students, the academic performance data for the first subset, and the academic performance data for the second subset, a new academic performance standard;
standardizing, using the new academic performance standard, the academic performance data for each of the identified students into standardized academic performance data; and
combining, using the unique identifier of each of the identified students, the standardized academic performance data, the enrollment data, and the financial aid data into an analytics database,
wherein the responsive financial aid information for the identified students further comprises information from the analytics database.

24. The method of claim 23, wherein the generating the new academic performance standard comprises:
dividing the first subset of the identified students into a first set of a predetermined number of ordered groups based on the performance of each of the identified students in the first subset according to the first academic performance standard;
dividing the second subset of the identified students into a second set of the predetermined number of ordered groups based on the performance of each of the identified students in the second subset according to the second academic performance standard; and
associating the ranking of each of the respective ordered groups from the first set with the corresponding group from the second set.

25. The method of claim 24, wherein the standardizing the academic performance data for each of the identified students into standardized academic performance data comprises ranking each of the identified students according to their respective ordered group.

26. The method of claim 25,
wherein the obtained academic performance data for the first subset and the second subset comprises a shared academic standard,
wherein the new academic performance standard is generated by:
dividing the identified students into a third set of the predetermined number of ordered groups based on the performance of each of the identified students according to the shared academic standard; and
associating the ranking of each of the respective ordered groups from the third set with the corresponding groups from the first set and the second set; and
wherein the standardizing the academic performance data for each of the identified students into standardized academic performance comprises:
assigning a first numeric value to each of the identified students from the first subset according to their respective ordered group from the first set;
assigning a second numeric value to each of the identified students from the second subset according to their respective ordered group from the second set;
assigning a third numeric value to each of the identified students according to their respective ordered group from the third set;
summing the numeric values associated with each of the identified students; and
ranking each of the identified students according to their associated sum value.

27. The method of claim 26,
wherein the shared academic standard is a grade point average, the first academic performance standard is a first standardized test, and the second academic performance standard is a second standardized test, and
wherein the assigned numeric values begin with 1.

28. The method of claim 17, wherein the first query comprises a plurality of parameters specified by the user, and wherein the first query is pre-defined by the user based on the specified plurality of parameters.

29. The method of claim 17, wherein the first query comprises a first parameter specified by the user, wherein the report is further based on the first parameter, and wherein the method further comprises:
receiving, from the user, a second query in response to the report, the second query comprising the first parameter and a second parameter; and
providing, to the user, another report for the identified student data in response to the second query, wherein the other report is based on the first parameter and the second parameter, and comprises a relationship between any of at least two of admissions data for the identified student data, enrollment data for the identified student data, and financial aid data for the identified student data.

30. The method of claim 17,
wherein the enrollment data comprises degree award information and academic performance information for the institution, and
wherein the subset of the identified student data comprise students that have graduated from the institution, and
wherein the responsive financial aid information comprises financial aid information, academic performance information, and degree award information for the graduated students.

31. The method of claim 17, wherein the method further comprises:
receiving, from the user, a second query in response to the responsive financial aid information; and
providing, to the user, a response to the second query comprising additional information for the subset of the identified student data associated with the responsive financial aid information, wherein the additional information comprises enumerated numerical data associated with the responsive financial aid information.

32. A machine-readable storage medium comprising machine-readable instructions for causing a processor to execute a method for analytically combining student admissions data, enrollment data, and financial aid data to present relationships therein, comprising:
obtaining admissions data for a plurality of students, enrollment data for a plurality of students, and financial aid data for a plurality of students;
identifying, from the admissions data, the enrollment data, and the financial aid data, students shared among any of at least two of the admissions data, the enrollment data, and the financial aid data;
associating each of the identified student data with a unique identifier;
receiving, from a user, a first query for a report for a subset of the identified student data; and
providing, to the user, the report for the subset of the identified student data,
wherein the report is generated by detecting at least two of admissions data, enrollment data, and financial aid data for the subset of the identified student data using the unique identifiers associated with the subset of the identified student data, and
wherein the report comprises a relationship between any of at least two of admissions data for the subset of the identified student data, enrollment data for the subset of the identified student data, and financial aid data for the subset of the identified student data.

33. The machine-readable storage medium of claim 32, wherein the identified student data comprises students identified as shared among any of at least two of the admissions data, the enrollment data, and the financial aid data, and wherein the report comprises an indication of the likelihood of enrollment of the subset of the identified students at the institution based on the financial aid offered to the subset of the identified students.

34. The machine-readable storage medium of claim 32, wherein the identified student data comprises students identified as shared among any of at least two of the admissions data, the enrollment data, and the financial aid data, and wherein the report comprises an indication of the likelihood of enrollment of the subset of the identified students at the institution based on at least one of the estimated average family contribution received by the subset of the identified students, the academic performance of the subset of the identified students, and the unmet financial needs of the subset of the identified students.

35. The machine-readable storage medium of claim 32, wherein the identified student data comprises students identified as shared among any of at least two of the admissions data, the enrollment data, and the financial aid data, and wherein the report comprises an indication of the likelihood of enrollment of the subset of the identified students at the institution based on the position in which the subset of the identified students listed the institution on a financial aid application.

36. The machine-readable storage medium of claim 32, wherein the identified student data comprises students identified as shared among any of at least two of the admissions data, the enrollment data, and the financial aid data, and wherein the report comprises an average amount of revenue generated from the attendance of the subset of the identified students at the institution.

37. The machine-readable storage medium of claim 32, wherein the identified student data comprises students identified as shared among any of at least two of the admissions data, the enrollment data, and the financial aid data, and wherein the report comprises an indication of the likelihood of continued enrollment of the subset of the identified students at the institution based on the financial aid received by the subset of the identified students.

38. The machine-readable storage medium of claim 32, wherein the identified student data comprises students identified as shared among any of at least two of the admissions data, the enrollment data, and the financial aid data, and the method further comprising:
obtaining, from the admissions data, academic performance data for each of the identified students, wherein the academic performance data for a first subset of the identified students is associated with a first academic performance standard and the academic performance data for a second subset of the identified students is associated with a second academic performance standard;
generating, based on the number of the identified students, the academic performance data for the first subset, and the academic performance data for the second subset, a new academic performance standard;
standardizing, using the new academic performance standard, the academic performance data for each of the identified students into standardized academic performance data; and
combining, using the unique identifier of each of the identified students, the standardized academic performance data, the enrollment data, and the financial aid data into an analytics database,
wherein the responsive financial aid information for the identified students further comprises information from the analytics database.

39. The machine-readable storage medium of claim 38, wherein the generating the new academic performance standard comprises:
dividing the first subset of the identified students into a first set of a predetermined number of ordered groups based on the performance of each of the identified students in the first subset according to the first academic performance standard;
dividing the second subset of the identified students into a second set of the predetermined number of ordered groups based on the performance of each of the identified students in the second subset according to the second academic performance standard; and
associating the ranking of each of the respective ordered groups from the first set with the corresponding group from the second set.

40. The machine-readable storage medium of claim 39, wherein the standardizing the academic performance data for each of the identified students into standardized academic performance data comprises ranking each of the identified students according to their respective ordered group.

41. The machine-readable storage medium of claim 40,
wherein the obtained academic performance data for the first subset and the second subset comprises a shared academic standard,
wherein the new academic performance standard is generated by:
dividing the identified students into a third set of the predetermined number of ordered groups based on the performance of each of the identified students according to the shared academic standard; and
associating the ranking of each of the respective ordered groups from the third set with the corresponding groups from the first set and the second set; and
wherein the standardizing the academic performance data for each of the identified students into standardized academic performance comprises:
assigning a first numeric value to each of the identified students from the first subset according to their respective ordered group from the first set;
assigning a second numeric value to each of the identified students from the second subset according to their respective ordered group from the second set;
assigning a third numeric value to each of the identified students according to their respective ordered group from the third set;
summing the numeric values associated with each of the identified students; and
ranking each of the identified students according to their associated sum value.

42. The machine-readable storage medium of claim 41,
wherein the shared academic standard is a grade point average, the first academic performance standard is a first standardized test, and the second academic performance standard is a second standardized test, and
wherein the assigned numeric values begin with 1.

43. The machine-readable storage medium of claim 32, wherein the first query comprises a plurality of parameters specified by the user, and wherein the first query is pre-defined by the user based on the specified plurality of parameters.

44. The machine-readable storage medium of claim 32, wherein the first query comprises a first parameter specified by the user, wherein the report is further based on the first parameter, and wherein the machine-readable storage medium further comprises:
receiving, from the user, a second query in response to the report, the second query comprising the first parameter and a second parameter; and
providing, to the user, another report for the subset of the identified student data in response to the second query, wherein the other report is based on the first parameter and the second parameter, and comprises a relationship between any of at least two of admissions data for the subset of the identified student data, enrollment data for the subset of the identified student data, and financial aid data for the subset of the identified student data.

45. The machine-readable storage medium of claim 32,
wherein the enrollment data comprises degree award information and academic performance information for the institution, and
wherein the subset of the identified student data comprise students that have graduated from the institution, and
wherein the responsive financial aid information comprises financial aid information, academic performance information, and degree award information for the graduated students.

46. The machine-readable storage medium of claim 32, wherein the machine-readable storage medium further comprises:
receiving, from the user, a second query in response to the responsive financial aid information; and
providing, to the user, a response to the second query comprising additional information for the subset of the identified student data associated with the responsive financial aid information, wherein the additional information comprises enumerated numerical data associated with the responsive financial aid information.
